(19) United States
(12) Patent Application Publication
(10) Pub. No.: US 2025/0358547 A1
(43) Pub. Date: Nov. 20, 2025

(54) INFORMATION PROCESSING DEVICE, INFORMATION PROCESSING SYSTEM, INFORMATION PROCESSING CIRCUIT, AND INFORMATION PROCESSING METHOD

(71) Applicant: Sony Semiconductor Solutions Corporation, Kanagawa (JP)

(72) Inventor: Yoshimitsu TAKAGI, Kanagawa (JP)

(73) Assignee: Sony Semiconductor Solutions Corporation, Kanagawa (JP)

(21) Appl. No.: 18/868,184

(22) PCT Filed: May 29, 2023
(86) PCT No.: PCT/JP2023/019917

§ 371 Date: Nov. 22, 2024

(30) Foreign Application Priority Data
Jun. 8, 2022 (JP) 2022-093343

(51) Int. Cl. H04N 25/78; H04N 25/79

(52) U.S. Cl. CPC H04N 25/78; H04N 25/79

(57) ABSTRACT

An information processing device according to an aspect of the present disclosure includes: a sensor that acquires image generation data; and a conversion circuit that converts the image generation data based on a predetermined interface or data format acquired by the sensor into image generation data based on another interface or data format compatible with a processor.

### FIELD

The present disclosure relates to an information processing device, an information processing system, an information processing circuit, and an information processing method.

### BACKGROUND

An RGB sensor is already widely used in smartphones, digital cameras, and the like, and an application processor at a subsequent stage thereof generally includes an interface (for example, Mobile Industry Processor Interface-Camera Serial Interface 2 (MIPI (registered trademark)-CSI2)), an image signal processing block (for example, Image Signal Processing (ISP)), and the like for realizing easy connection (see, for example, Patent Literature 1). In addition, at present, special sensors other than the RGB sensor have been developed as sensors that acquire image generation data. As the special sensors, for example, there are an event base vision sensor (EVS), a multispectral scanner (MSS), a polarization sensor, and the like.

### CITATION LIST

### Patent Literature

Patent Literature 1: WO 2020/116046 A

### SUMMARY

### Technical Problem

However, since the special sensors have not yet been generally widespread in the world, even if a special sensor is connected to a general-purpose application processor, the general-purpose application processor may be incompatible with an interface (for example, Sub Low Voltage Differential Signaling (SubLVDS) or the like) of the special sensor, and thus incapable of receiving RAW data and executing signal processing. In addition, depending on the type of special sensor, despite an MIPI output, an interface (I/F) block of the MIPI on the application processor side may be compatible only with a specific data type (DT) so that a storage process of storing RAW data in a memory cannot be performed.

Therefore, the present disclosure provides an information processing device, an information processing system, an information processing circuit, and an information processing method that enable a processor to execute desired processing on image generation data acquired by a sensor.

### Solution to Problem

An information processing device according to an aspect of the present disclosure includes: a sensor that acquires image generation data; and a conversion circuit that converts the image generation data based on a predetermined interface or data format acquired by the sensor into image generation data based on another interface or data format compatible with a processor.

An information processing system according to an aspect of the present disclosure includes: a sensor that acquires image generation data; a conversion circuit that converts the image generation data based on a predetermined interface or data format acquired by the sensor into image generation data based on another interface or data format compatible with a processor; the processor that processes the image generation data converted by the conversion circuit; and a server device that manages data to be used by the conversion circuit or the processor.

An information processing circuit according to an aspect of the present disclosure that converts image generation data based on a predetermined interface or data format acquired by a sensor into image generation data based on another interface or data format compatible with a processor.

An information processing method according to an aspect of the present disclosure includes converting image generation data based on a predetermined interface or data format acquired by a sensor into image generation data based on another interface or data format compatible with a processor.

### BRIEF DESCRIPTION OF DRAWINGS

FIG. 1 is a diagram illustrating a configuration example of an information processing device according to an embodiment.

FIG. 2 is a diagram for describing an example of conversion processing of a conversion circuit according to the embodiment.

FIG. 3 is a diagram illustrating a configuration example of an EVS according to the embodiment.

FIG. 4 is a diagram illustrating a configuration example of a unit pixel according to the embodiment.

FIG. 5 is a diagram illustrating a configuration example of an address event detection unit according to the embodiment.

FIG. 6 is a diagram illustrating an example of a board configuration of the information processing device according to the embodiment.

FIG. 7 is a diagram illustrating an example of a board configuration of a special sensor and the conversion circuit according to the embodiment.

FIG. 8 is a diagram illustrating an example of the board configuration of the special sensor and the conversion circuit according to the embodiment.

FIG. 9 is a diagram illustrating a first configuration example of an information processing system according to the embodiment.

FIG. 10 is a view illustrating an example of a sensor information management table according to the embodiment.

FIG. 11 is a view for describing a flow of a first processing example of the information processing system according to the embodiment.

FIG. 12 is a diagram illustrating a second configuration example of the information processing system according to the embodiment.

FIG. 13 is a view for describing a flow of a second processing example of the information processing system according to the embodiment.

FIG. 14 is a block diagram illustrating a schematic configuration example of the information processing system as the embodiment.

FIG. 15 is an explanatory diagram of a method of registering an AI model and AI-using software in the information processing device as a cloud side.

FIG. 16 is a flowchart illustrating a processing example when an AI model and AI-using software are registered in the information processing device as the cloud side.

FIG. 17 is a block diagram illustrating an example of a hardware configuration of the information processing device as the embodiment.

FIG. 18 is a block diagram illustrating a configuration example of an imaging device as the embodiment.

FIG. 19 is a functional block diagram for describing functions related to system abuse prevention included in the information processing device as the embodiment.

FIG. 20 is a flowchart of processing corresponding to registration of an account of a user in the information processing system as the embodiment.

FIG. 21 is a flowchart of processing corresponding to from purchase to deployment of AI-using software and an AI model in the information processing system as the embodiment.

FIG. 22 is a flowchart illustrating a specific processing example of a use control unit included in the information processing device as the embodiment.

FIG. 23 is a functional block diagram for describing functions related to security control included in the imaging device as the embodiment.

FIG. 24 is a flowchart illustrating a specific processing example of a security control unit included in the imaging device as the embodiment.

FIG. 25 is an explanatory diagram of an example of a connection between a cloud and an edge.

FIG. 26 is an explanatory diagram of an example of a structure of an image sensor.

FIG. 27 is an explanatory diagram of deployment using a container technology.

FIG. 28 is an explanatory diagram of a specific configuration example of a cluster constructed by a container engine and an orchestration tool.

FIG. 29 is an explanatory diagram of an example of a flow of processing related to AI model relearning.

FIG. 30 is a view illustrating an example of a login screen related to a marketplace.

FIG. 31 is a view illustrating an example of a developer-oriented screen related to the marketplace.

FIG. 32 is a view illustrating an example of a user-oriented screen related to the marketplace.

### DESCRIPTION OF EMBODIMENTS

Hereinafter, embodiments of the present disclosure will be described in detail with reference to the drawings. Note that a device, a system, a circuit, a method, and the like according to the present disclosure are not limited by the embodiments. In addition, the same portions are basically denoted by the same reference signs in each of the following embodiments, and a repetitive description thereof will be omitted.

One or a plurality of embodiments (including examples and modifications) to be described hereinafter can be implemented independently. Meanwhile, at least some of the plurality of embodiments to be described hereinafter may be implemented appropriately in combination with at least some of other embodiments. The plurality of embodiments may include novel features different from each other. Therefore, the plurality of embodiments can contribute to achieving mutually different objects or solutions to problems, and can exhibit mutually different effects.

The present disclosure will be described in the following item order.
1. Embodiment
1-1. Configuration Example of Information Processing Device
1-2. Example of Conversion Processing of Conversion Circuit
1-3. EVS
1-3-1. Configuration Example of EVS
1-3-2. Configuration Example of Unit Pixel
1-3-3. Configuration Example of Address Event Detection Unit
1-4. Example of Board Configuration of Information Processing Device
1-5. Logic Update of Conversion Circuit
1-5-1. First Configuration Example of Information Processing System
1-5-2. First Processing Example of Information Processing System
1-5-3. Second Configuration Example of Information Processing System
1-5-4. Second Processing Example of Information Processing System
1-6. Action and Effect
2. Application Example
2-1. Information Processing System
2-1-1. Overall Configuration of System
2-1-2. Registration of AI Model and AI Software
2-1-3. Configuration of Information Processing Device
2-1-4. Configuration of Imaging Device
2-2. System Abuse Prevention Processing as Embodiment
2-3. Output Data Security Processing as Embodiment
2-4. Modifications
2-4-1. Connection between Cloud and Edge
2-4-2. Sensor Structure
2-4-3. Deployment Using Container Technology
2-4-4. Flow of Processing Related to AI Model Relearning
2-4-5. Screen Example of Marketplace
2-4-6. Other Modifications
2-5. Summary of Embodiment
3. Other Embodiments
4. Appendix

### 1. Embodiment

### <1-1. Configuration Example of Information Processing Device>

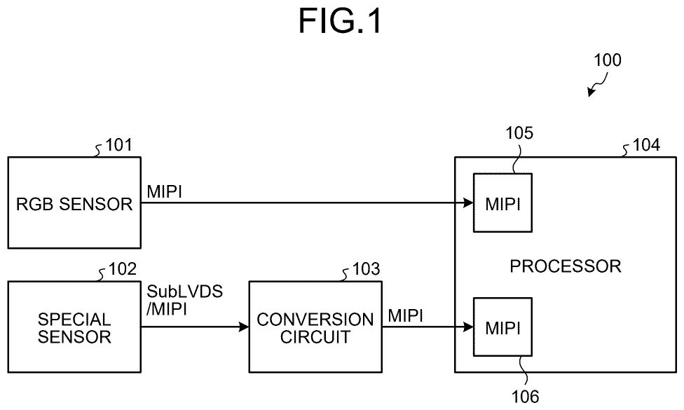

A configuration example of an information processing device 100 according to the present embodiment will be described with reference to FIG. 1. FIG. 1 is a diagram illustrating the configuration example of the information processing device 100 according to the present embodiment.

As illustrated in FIG. 1, the information processing device 100 according to the present embodiment includes an RGB sensor 101, a special sensor 102, a conversion circuit 103, and a processor 104.

The RGB sensor 101 is a sensor that acquires wavelength information (for example, RGB values) of three bands of RGB as image generation data. The RGB sensor 101 is connected to the processor 104 based on MIPI (for example, MIPI-CSI2 or the like). For example, the processor 104 generates an image (for example, a color image) based on each piece of the wavelength information.

Here, the MIPI is an interface standard for mobile devices. This MIPI is used in, for example, a camera, a display, and the like. A balanced (differential) communication system is adopted, and there are two standards of D-PHY (up to 1.0 Gbps per lane) and M-PHY (up to 6 Gbps per lane) in physical layers.

The special sensor 102 is a sensor, which acquires image generation data, other than the RGB sensor 101. The special sensor 102 is connected to the conversion circuit 103 based on SubLVDS or MIPI (for example, MIPI-CSI2 or the like).

Here, LVDS is one of differential transmission systems in which two signal lines are paired and a signal is transmitted using a difference in voltage between the two signal lines, and is an interface standard that normally uses a constant current source of 3.5 mA to transmit data at a high speed using a differential signal having a low amplitude of 350 mV (low voltage differential signal). The SubLVDS is an interface standard that transmits data at a high speed using a differential signal having a lower amplitude than that of the LVDS, and normally uses the differential signal having a low amplitude of 150 mV using a constant current source of 1.5 mA. This makes it possible to transmit the signal at a high speed with less power consumption.

Examples of the special sensor 102 include a polarization sensor (polarization image sensor), a multispectral scanner (MSS), and an event based vision sensor (EVS). Note that various sensors other than the exemplified sensors, such as a hyperspectral sensor, can also be used as the special sensor 102.

The polarization sensor is a sensor that acquires polarization information such as a polarization direction and a polarization degree as image generation data. A polarized image in a predetermined direction is generated by the processor 104 at a subsequent stage based on the polarization information. The polarization sensor 102a captures polarized light that is a vibration direction of light and cannot be recognized by human eyes, thereby facilitating detection of a scratch, foreign matter, a strain, and the like on an object surface, recognition of the object shape, and the like. As the polarization sensor 102a, for example, there is a polarization sensor that has polarizers in four directions and acquires polarized images in the four directions by one shot. The polarization direction (vibration direction of light) and the polarization degree (degree of polarization) can be calculated from a luminance value of the polarizer in each of the directions.

The MSS is a multi-wavelength spectral sensor that acquires, as image generation data, pieces of wavelength information (for example, wavelength values) of more bands than the RGB sensor 101, for example, ten bands. From these pieces of wavelength information, a two-dimensional image for each piece of wavelength information is generated at a subsequent stage. A set of the images for the pieces of wavelength information is called a data cube. The data cube is an image in which the two-dimensional image is generated for each spectral wavelength to form a layer. The MSS can visualize information that cannot be identified by human eyes by capturing light of a specific wavelength reflected from a target object.

The EVS is a sensor that outputs event information as image generation data. From this event information, an EVS image is generated by the processor 104 at a subsequent stage. The EVS is an image sensor using a smart pixel. The smart pixel is inspired by the action of human eyes and can instantaneously recognize not only a stationary object but also a moving object. In the EVS, incident light is converted into an electric signal by a light receiving circuit of the sensor, and the electric signal passes through an amplifier and is separated by a comparator according to a luminance change, and is output as a light change signal (positive event) or a dark change signal (negative event). This EVS will be described in detail later.

The RGB sensor 101 and the special sensor 102 as described above are formed to be detachably attached to the information processing device 100, are mounted on the information processing device 100, and are connected to the processor 104. The special sensor 102 and the RGB sensor 101 are attached or detached in accordance with an application. For example, the special sensor 102 is selected from among the polarization sensor, the MSS, the EVS, and the like according to an application, and is attached to the information processing device 100.

The conversion circuit 103 is a circuit that performs various types of conversion processing such as interface conversion and format conversion. The conversion circuit 103 is connected to the processor 104 based on MIPI (for example, MIPI-CSI2 or the like).

For example, the conversion circuit 103 converts data (image generation data) based on a predetermined interface or data format output from the special sensor 102 into data (image generation data) based on another interface or data format compatible with the processor 104 and outputs the converted data. Specifically, for example, the conversion circuit 103 converts data based on SubLVDS into data based on MIPI compatible with the processor 104, or converts data based on a format compatible with the special sensor 102 into data based on a format compatible with the processor 104. As a result, the processor 104 can process the data. This conversion processing will be described below in detail.

Here, the term “interface” (interface standard) means, for example, one that defines a procedure, a rule, and the like for exchanging information, signals, and the like between two parties. In addition, the term “data format” means, for example, a format of data for exchanging information, signals, and the like between two parties.

The conversion circuit 103 is configured using, for example, a field programmable gate array (FPGA), an application specific integrated circuit (ASIC), or the like. The FPGA is a logic circuit that can be programmed in a field. This FPGA is, for example, a device in which gates (logic circuits) are integrated, configurations of the logic circuits being programmable in a field by a designer. An internal circuit configuration, that is, processing content can be changed by a program with respect to an LSI (integrated circuit) whose circuit configuration cannot be changed after manufacturing. The ASIC is an integrated circuit in which circuits having a plurality of functions are integrated for a specific application.

The processor 104 is realized by a processor such as a central processing unit (CPU) and a micro-processing unit (MPU). To the processor 104, the RGB sensor 101 is connected via an I/F block 105 of MIPI, and the conversion circuit 103 is connected via an I/F block 106 of MIPI. Data output from the RGB sensor 101 is directly input to the processor 104, and data output from the special sensor 102 is input to the processor 104 via the conversion circuit 103.

The processor 104 executes various programs using, for example, a random access memory (RAM) or the like as a work area, but may be realized by an integrated circuit such as an ASIC or an FPGA. All the CPU, MPU, ASIC, and FPGA can be regarded as processors. In addition, the processor 104 may be realized by a graphics processing unit (GPU) in addition to or instead of the CPU. In addition, the processor 104 may be realized by specific software instead of specific hardware.

Such a processor 104 executes, for example, an application that generates an image. Examples of the application include various applications such as a general-purpose application and a dedicated application. In addition, other than the application that generates an image, for example, there is an application that detects an object. This object detection (object recognition) application may be realized by, for example, artificial intelligence (AI). In addition, the object detection application may be executed, for example, based on a learned model by a neural network (for example, a convolutional neural network (CNN) or the like) which is an example of machine learning, or may be executed based on other methods.

### 1-2. Example of Conversion Processing of Conversion Circuit

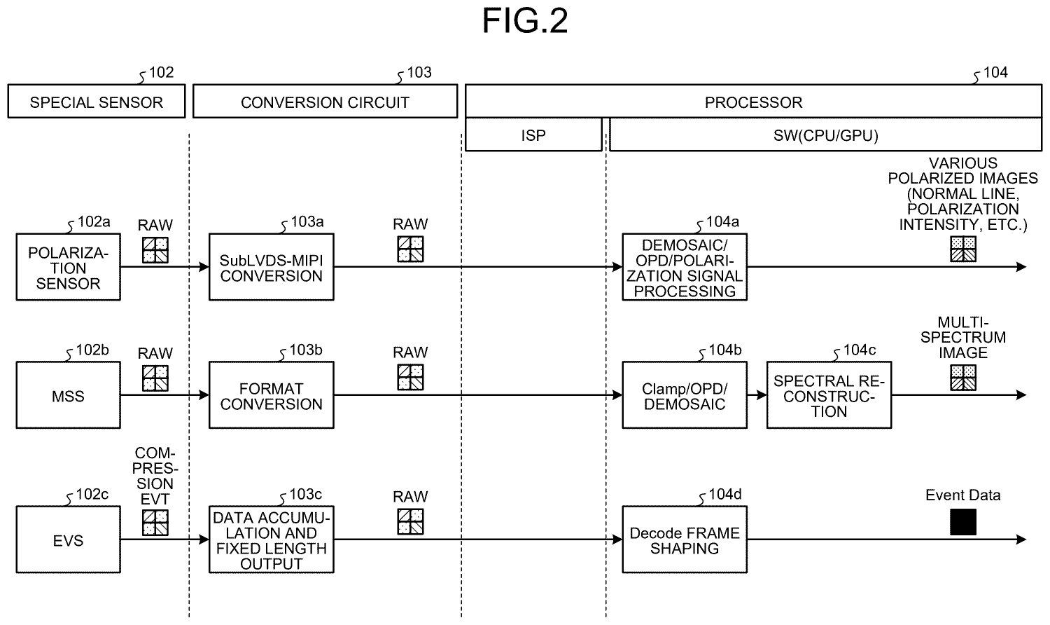

An example of conversion processing of the conversion circuit 103 according to the present embodiment will be described with reference to FIG. 2. FIG. 2 is a diagram for describing the example of conversion processing of the conversion circuit 103 according to the present embodiment. In the example of FIG. 2, polarization sensors 102a, an MSS 102b, and an EVS 102c are illustrated as the special sensors 102, and processing corresponding thereto is illustrated.

As illustrated in FIG. 2, when the polarization sensor 102a is used as the special sensor 102, the conversion circuit 103 includes a processing block 103a that converts data based on SubLVDS into data based on MIPI compatible with the processor 104 and outputs the converted data to the processor 104. In addition, the processor 104 includes a processing block 104a that executes demosaic/optical detector (OPD)/polarization signal processing by software (SW). As a result, various polarized images (normal line, polarization intensity, etc.) are generated.

Here, the term “demosaic” is to complement color information by collecting insufficient color information from peripheral pixels for each pixel to create a full-color image and create a full-color image. The term “OPD” is to perform detection processing, and specifically to detect (integrate) luminance signal components or chroma signal components in a certain period, for example, one field period. The term “polarization signal processing” is processing for generating a polarized image.

Next, when the MSS 102b is used as the special sensor 102, the conversion circuit 103 includes a processing block 103b that converts data based on a format compatible with the MSS 102b into data based on a format compatible with the processor 104 and outputs the converted data to the processor 104. In addition, the processor 104 includes a processing block 104b that executes Clamp/OPD/demosaic by software (SW) and a processing block 104c that executes spectral reconstruction. As a result, a multi-spectrum image is generated. The multi-spectrum image is an image in which electromagnetic waves of a plurality of wavelength bands are recorded.

Here, the term “clamp” is to fix a black level. Specifically, in a composite video signal and a luminance signal, the black level is used as a reference, and a DC voltage value represents information. Therefore, in signal processing, the black level is fixed, and the signal processing is performed based on this level. This level fixation is called clamp. The term “spectral reconstruction” is processing for generating a multi-spectrum image.

Next, when the EVS 102c is used as the special sensor 102, the conversion circuit 103 includes a processing block 103c that converts data (for example, compression event information) based on a format compatible with the EVS 102c into data (for example, data for output having a fixed length by data accumulation) based on a format compatible with the processor 104 and outputs the converted data to the processor 104. In addition, the processor 104 includes a processing block 104d that executes decode frame shaping by software (SW). As a result, event information (EVS image) is generated.

Here, the term “decode frame shaping” is processing for decoding data to shape a frame and generating an EVS image including event information.

As described above, the conversion circuit 103 changes and executes the conversion processing according to the type of the special sensor 102. For example, in a case where the conversion circuit 103 is a non-programmable logic circuit such as an ASIC, when the special sensor 102 is changed, the conversion circuit 103 may be changed together. Alternatively, in a case where the conversion circuit 103 is a programmable logic circuit such as an FPGA, logic of the conversion circuit 103 may be rewritten and the conversion processing may be changed according to the type of the special sensor 102 to be used. The change of the conversion processing for the programmable logic circuit will be described in detail later.

Note that, in the example of FIG. 2, image signal processing (ISP) of the processor 104 is used by the RGB sensor 101. The ISP executes image processing on raw data output from the RGB sensor 101, for example, and generates image data (for example, color image data).

### 1-3. EVS

### 1-3-1. Configuration Example of EVS

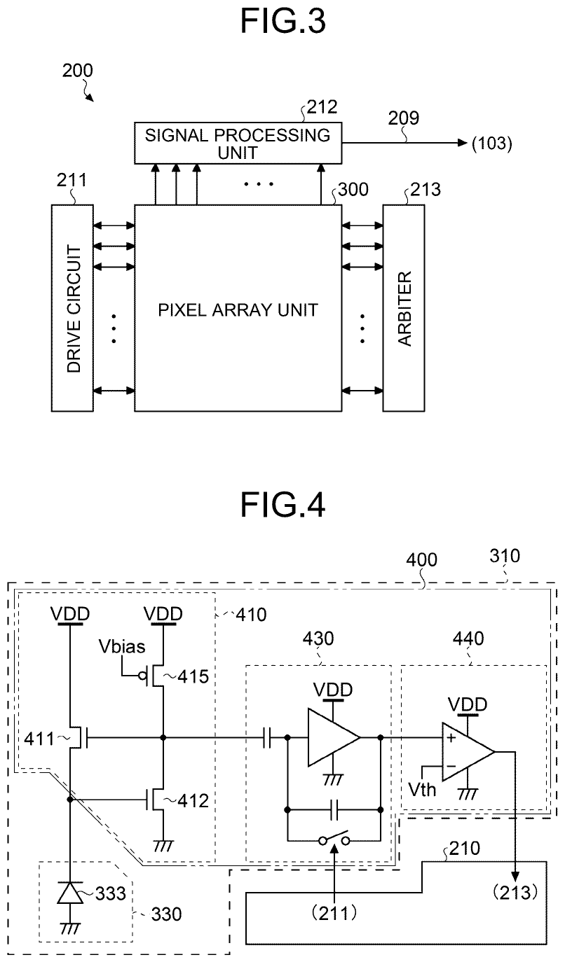

A configuration example of an EVS 200 according to the present embodiment will be described with reference to FIG. 3. FIG. 3 is a diagram illustrating a configuration example of the EVS 200 according to the present embodiment. This EVS 200 corresponds to the EVS 102c described above.

As illustrated in FIG. 3, the EVS 200 according to the present embodiment includes a drive circuit 211, a signal processing unit 212, an arbiter 213, and a pixel array unit 300.

The EVS 200 is an example of an asynchronous image sensor in which a detection circuit detecting that an amount of received light exceeds a threshold in real time as an address event is provided for each pixel. For example, the EVS 200 adopts a so-called event-driven drive system in which presence or absence of occurrence of an address event is detected for each unit pixel, and a pixel signal is read from a unit pixel in which an address event has occurred when the occurrence of the address event is detected.

For example, the EVS 200 detects the occurrence of the address event based on an amount of incident light, and generates address information for specifying the unit pixel in which the occurrence of the address event is detected as event detection data. The event detection data may include time information such as a time stamp indicating a timing at which the occurrence of the address event is detected. The term “address event” is an event that occurs for each address assigned to each of a plurality of unit pixels arrayed in a two-dimensional lattice pattern, and is, for example, that a current value of a current (hereinafter, referred to as photocurrent) based on charge generated in a photoelectric conversion element or a change amount thereof exceeds a certain threshold.

In the pixel array unit 300, a plurality of unit pixels are arrayed in a two-dimensional lattice pattern. As will be described in detail later, the unit pixel includes, for example, a photoelectric conversion element such as a photodiode, and a pixel circuit (corresponding to an address event detection unit 400 to be described below in the present embodiment) that detects presence or absence of occurrence of an address event based on whether a current value of a photocurrent based on charge generated in the photoelectric conversion element or a change amount thereof exceeds a predetermined threshold. Here, the pixel circuit can be shared by a plurality of the photoelectric conversion elements. In that case, each of the unit pixels includes one photoelectric conversion element and the shared pixel circuit.

The plurality of unit pixels of the pixel array unit 300 may be grouped into a plurality of pixel blocks each including a predetermined number of unit pixels. Hereinafter, a set of unit pixels or pixel blocks arrayed in the horizontal direction is referred to as a “row”, and a set of unit pixels or pixel blocks arrayed in a direction perpendicular to the row is referred to as a “column”.

When occurrence of an address event is detected in the pixel circuit, each of the unit pixels outputs a request for reading a signal from the unit pixel to the arbiter 213.

The arbiter 213 arbitrates the request from one or more unit pixels, and transmits a predetermined response to the unit pixel that has issued the request based on a result of the arbitration. The unit pixel that has received this response output a detection signal indicating the occurrence of the address event to the drive circuit 211 and the signal processing unit 212.

The drive circuit 211 sequentially drives the unit pixel that has output the detection signal to output, for example, a signal corresponding to an amount of received light from the unit pixel in which the occurrence of the address event has been detected to the signal processing unit 212. Note that the EVS 200 may be provided with, for example, an analog-to-digital converter for converting a signal read from a photoelectric conversion element 333 to be described below into a signal of a digital value according to an amount of charge thereof, for each of one or a plurality of unit pixels or for each column.

The signal processing unit 212 performs predetermined signal processing on the signal input from the unit pixel, and supplies a result of the signal processing as event detection data to the conversion circuit 103 via a signal line 209. Note that, as described above, the event detection data can include address information of the unit pixel in which the occurrence of the address event has been detected, and time information such as a time stamp indicating a timing at which the address event has occurred.

### 1-3-2. Configuration Example of Unit Pixel

A configuration example of a unit pixel 310 according to the present embodiment will be described with reference to FIG. 4. FIG. 4 is a diagram illustrating the configuration example of the unit pixel according to the present embodiment.

As illustrated in FIG. 4, the unit pixel 310 includes, for example, a light receiving unit 330 and the address event detection unit 400. Note that a logic circuit 210 in FIG. 4 may be, for example, a logic circuit including the drive circuit 211, the signal processing unit 212, and the arbiter 213 in FIG. 3.

The light receiving unit 330 includes, for example, the photoelectric conversion element 333 such as a photodiode, and an output thereof is connected to the address event detection unit 400.

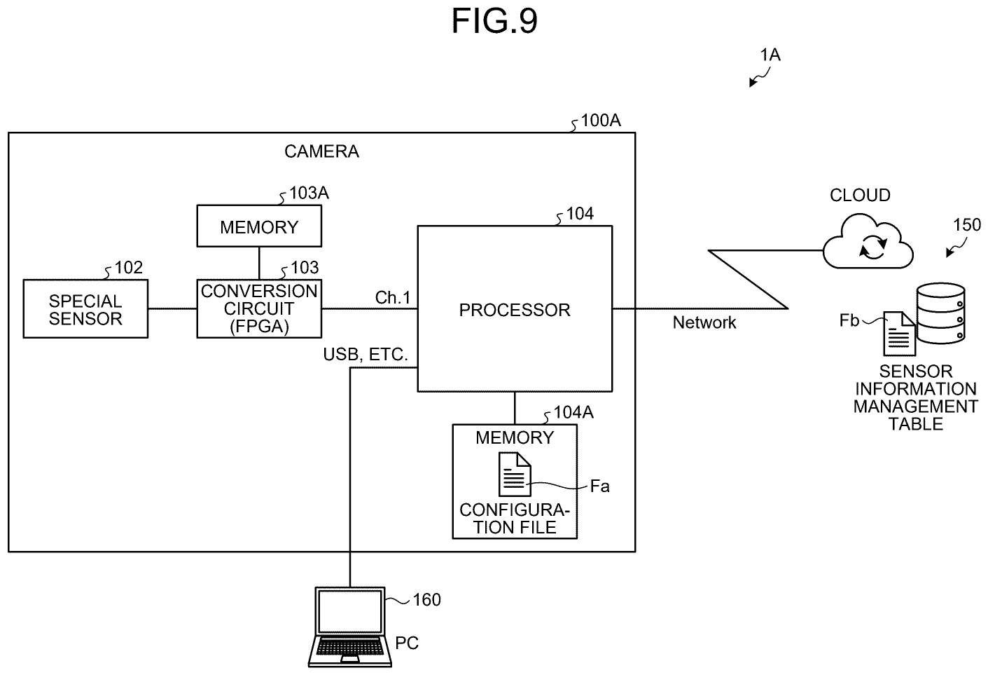

The address event detection unit 400 includes, for example, a current-voltage conversion unit 410 and a subtractor 430. In addition to these, the address event detection unit 400 includes a buffer, a quantizer, and a transfer unit. Details of the address event detection unit 400 will be described below with reference to FIG. 9.

In such a configuration, the photoelectric conversion element 333 of the light receiving unit 330 photoelectrically converts incident light to generate charge. The charge generated in the photoelectric conversion element 333 is input to the address event detection unit 400 as a photocurrent having a current value corresponding to an amount of the charge.

Here, as illustrated in FIG. 4, the current-voltage conversion unit 410 may be, for example, a so-called source follower current-voltage conversion unit including an LG transistor 411, an amplification transistor 412, and a constant current circuit 415. Note that the current-voltage conversion unit 410 is not limited to the source follower current-voltage conversion unit, and may be, for example, a so-called gain boost current-voltage conversion unit.

A source of the LG transistor 411 and a gate of the amplification transistor 412 are connected to, for example, a cathode of the photoelectric conversion element 333 of the light receiving unit 330. In addition, a drain of the LG transistor 411 is connected to a power supply terminal VDD, for example. The amplification transistor 412 has a source that is grounded and a drain connected to the power supply terminal VDD via the constant current circuit 415. The constant current circuit 415 may include, for example, a load MOS transistor such as a P-type metal-oxide-semiconductor (MOS) transistor.

A loop-shaped source follower circuit is configured by the connection relationship as illustrated in FIG. 4. As a result, the photocurrent from the light receiving unit 330 is converted into a voltage signal having a logarithmic value corresponding to the amount of charge. Note that each of the LG transistor 411 and the amplification transistor 412 may include, for example, an NMOS transistor.

### 1-3-3. Configuration Example of Address Event Detection Unit

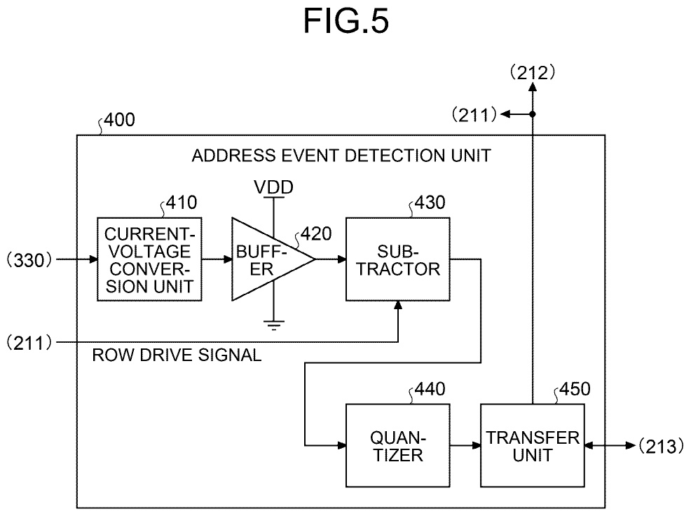

A configuration example of the address event detection unit 400 according to the present embodiment will be described with reference to FIG. 5. FIG. 5 is a diagram illustrating the configuration example of the address event detection unit 400 according to the present embodiment.

As illustrated in FIG. 5, the address event detection unit 400 includes a buffer 420 and a transfer unit 450 in addition to the current-voltage conversion unit 410, the subtractor 430, and the quantizer 440 also illustrated in FIG. 4.

The current-voltage conversion unit 410 converts a photocurrent from the light receiving unit 330 into a logarithmic voltage signal, and outputs the voltage signal generated by the conversion to the buffer 420.

The buffer 420 corrects the voltage signal from the current-voltage conversion unit 410 and outputs the corrected voltage signal to the subtractor 430.

The subtractor 430 lowers a voltage level of the voltage signal from the buffer 420 according to a row drive signal from the drive circuit 211, and outputs the lowered voltage signal to the quantizer 440.

The quantizer 440 quantizes the voltage signal from the subtractor 430 into a digital signal, and outputs the digital signal thus generated to the transfer unit 450 as a detection signal.

The transfer unit 450 transfers the detection signal from the quantizer 440 to the signal processing unit 212 and the like. For example, when occurrence of an address event is detected, the transfer unit 450 outputs, to the arbiter 213, a request for requesting transmission of a detection signal of the address event from the transfer unit 450 to the drive circuit 211 and the signal processing unit 212. Then, when a response to the request is received from the arbiter 213, the transfer unit 450 outputs the detection signal to the drive circuit 211 and the signal processing unit 212.

### 1-4. Example of Board Configuration of Information Processing Device

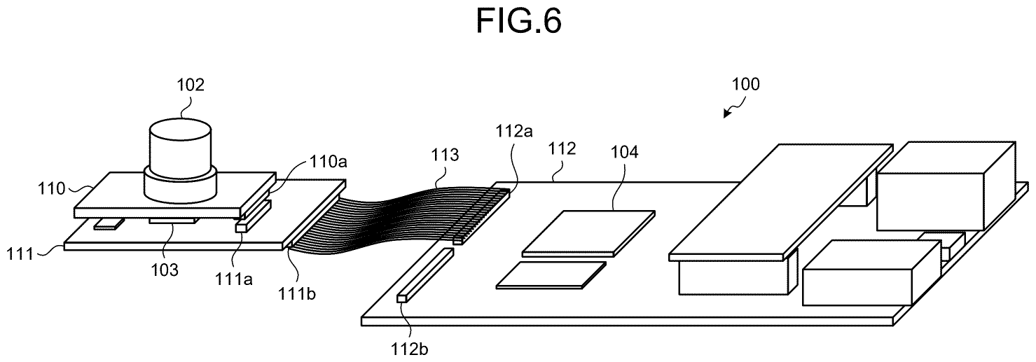

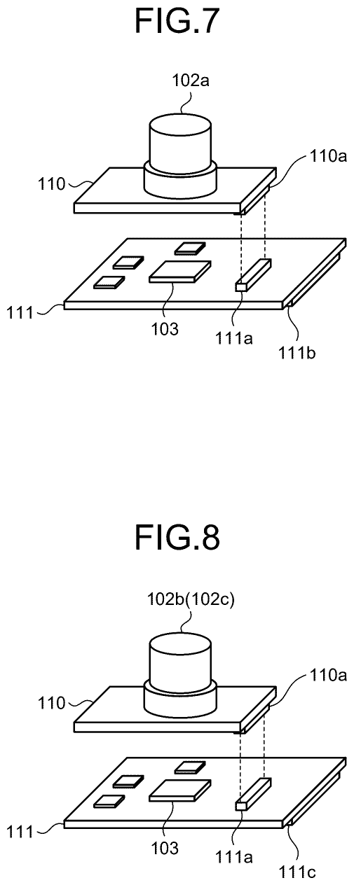

An example of a board configuration of the information processing device 100 according to the present embodiment will be described with reference to FIGS. 6 to 8. FIG. 6 is a diagram illustrating the example of the board configuration of the information processing device 100 according to the present embodiment. Each of FIGS. 7 and 8 is a diagram illustrating an example of a board configuration of the special sensor 102 (the polarization sensor 102a, the MSS 102b, or the EVS 102c) and the conversion circuit 103 according to the present embodiment.

As illustrated in FIG. 6, the information processing device 100 includes a sensor board 110, a circuit board 111, a processor board 112, and a connection cable 113. Each of the boards 110 to 112 includes, for example, a printed circuit board or the like.

The sensor board 110 includes the special sensor 102 and the like. The special sensor 102 is provided on a surface (upper face in FIG. 6) of the sensor board 110. In addition, the sensor board 110 includes a connection connector 110a. The connection connector 110a is provided on a face (lower face in FIG. 6) of the sensor board 110 opposite to a face on which the special sensor 102 is provided.

The circuit board 111 includes the conversion circuit 103 and the like. The conversion circuit 103 is provided on a surface (upper face in FIG. 6) of the circuit board 111. In addition, the circuit board 111 includes a connection connector 111a and an output connector 111b.

The connection connector 111a is provided on a face of the sensor board 110 on which the conversion circuit 103 is provided, that is, the surface (upper face in FIG. 6) of the circuit board 111. The output connector 111b is provided on a face (lower face in FIG. 6) of the sensor board 110 opposite to the face on which the conversion circuit 103 is provided.

The sensor board 110 and the circuit board 111 are stacked by fitting the connection connector 110a and the connection connector 111a to each other, and the special sensor 102 and the conversion circuit 103 are electrically connected via the connection connector 110a and the connection connector 111a.

Specifically, the connection connector 110a and the connection connector 111a are formed to be fittable and to be detachably attached. As a result, the sensor board 110 and the circuit board 111 are detachably attached. The connection connector 110a and the connection connector 111a are arranged at positions facing each other to be located on the circuit board 111 in a state where the sensor board 110 is stacked on the circuit board 111. The connection connector 110a and the connection connector 111a function as coupling connectors that directly couple the sensor board 110 and the circuit board 111.

Note that the connection connector 110a and the connection connector 111a are directly coupled and connected, but other than this configuration, may be connected, for example, via a connection cable other than this configuration. However, it is desirable that the connection connector 110a and the connection connector 111a are directly coupled and connected in order to reduce the number of parts and the like.

The processor board 112 includes the processor 104 and the like. The processor 104 is provided on a surface (upper face in FIG. 6) of the processor board 112. In addition, the processor board 112 includes an input connector 112a and an input connector 112b. The input connectors 112a and 112b are provided on the same face as a face of the processor board 112 on which the processor 104 is provided, that is, the surface (upper face in FIG. 6) of the processor board 112.

The circuit board 111 and the processor board 112 are connected via the connection cable 113. Specifically, the output connector 111b of the circuit board 111 and the input connector 112a of the processor board 112 are connected by the connection cable 113. Note that, since the processor board 112 is provided with the plurality of input connectors 112a and 112b, a plurality of sensors can be connected thereto through various types of the special sensors 102, the RGB sensor 101, and the like.

Here, the output connector 111b of the circuit board 111, the input connector 112a and the input connector 112b of the processor board 112 are, for example, connectors based on MIPI (MIPI standard). On the other hand, the connection connector 110a of the sensor board 110 and the connection connector 111a of the circuit board 111 are connectors based on an interface compatible with the type of the special sensor 102, for example, SubLVDS or MIPI (SubLVDS standard or MIPI standard).

For example, when the polarization sensor 102a is used as the special sensor 102 as illustrated in FIG. 7, the connection connector 110a of the sensor board 110 and the connection connector 111a of the circuit board 111 are connectors based on the SubLVDS. On the other hand, when the MSS 102b (or EVS 102c) is used as the special sensor 102 as illustrated in FIG. 8, the connection connector 110a of the sensor board 110 and the connection connector 111a of the circuit board 111 are connectors based on the MIPI.

According to the example of the board configuration as described above, the sensor board 110 is detachably attached to the circuit board 111, and the circuit board 111 is detachably attached to the processor board 112 via the connection cable 113. Therefore, the special sensor 102 is detachably attached to the circuit board 111 together with the sensor board 110, and the special sensor 102 is detachably attached to the processor board 112 together with the sensor board 110 and the circuit board 111 (a module).

Note that the board configuration of the special sensor 102 has been described as described above, whereas, in a board configuration of the RGB sensor 101, the sensor board 110 includes the RGB sensor 101 and the connection connector (output connector) 110a, for example. The connection connector 110a of the sensor board 110 and the input connector 112a (or 112b) of the processor board 112 are connected by the connection cable 113. In this manner, the sensor board 110 of the RGB sensor 101 and the processor board 112 are connected via the connection cable 113.

### <1-5. Logic Update of Conversion Circuit>

In a logic update of the conversion circuit 103 (for example, FPGA) according to the present embodiment, it is possible to cope with different types of special sensors even in a case where the sensor board 110 is replaced and the like since a mechanism for rewriting a bit stream of the conversion circuit 103 from the outside such as a cloud server is provided. The logic update of the conversion circuit 103 will be described in detail hereinafter.

### 1-5-1. First Configuration Example of Information Processing System

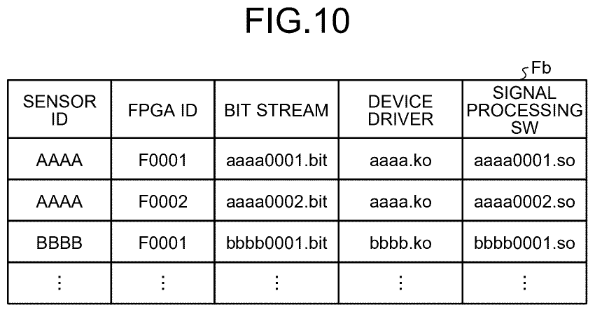

A first configuration example of an information processing system 1A according to the present embodiment will be described with reference to FIGS. 9 and 10. FIG. 9 is a diagram illustrating the first configuration example of the information processing system 1A according to the present embodiment. FIG. 10 is a diagram illustrating an example of a sensor information management table Fb according to the present embodiment.

As illustrated in FIG. 9, the information processing system 1A includes a camera 100A, a server device 150, and a terminal device 160. The camera 100A is an imaging device to which the above-described information processing device 100 is applied.

In the example of FIG. 9, the conversion circuit 103 is an FPGA, and a memory 103A is connected to the conversion circuit 103. The memory 103A stores, for example, a bit stream which is information for updating logic of the conversion circuit 103. Note that, similarly to the conversion circuit 103, the memory 103A is also provided on the circuit board 111 (see FIG. 6).

In addition, a memory 104A is also connected to the processor 104. The memory 104A stores, for example, a configuration file Fa. Note that, similarly to the processor 104, the memory 104A is also provided on the processor board 112 (see FIG. 6).

The configuration file Fa includes configuration information related to the special sensor 102 and the conversion circuit 103. For example, the configuration file Fa includes information such as the number of sensors to be connected, a sensor ID (identification) for each channel, and an “FPGA ID” for each channel. In the example of FIG. 9, only one special sensor 102 is connected to channel Ch.1 of the processor 104. A plurality of channels are prepared, and various types of the special sensors 102, the RGB sensor 101, and the like can be connected.

The server device 150 is, for example, a cloud server, and stores various types of information such as the sensor information management table Fb. The server device 150 is connected to the camera 100A via a network. As the server device 150, for example, a server such as a PC server, a midrange server, or a mainframe server may be used other than the cloud server. Note that the server device 150 and the camera 100A mutually have communication units and the like, and thus can communicate with each other via the network.

As illustrated in FIG. 10, the sensor information management table Fb includes sensor information such as a sensor ID, an FPGA ID, a bit stream, a device driver, and signal processing software (SW). In the example of FIG. 10, the bit stream, the device driver, and the signal processing software are set for each pair of the sensor ID and the FPGA ID. The sensor information management table Fb is, for example, management information for managing sensor information compatible with the special sensor 102.

The sensor ID is ID information regarding an ID of the special sensor 102. The special sensor 102 is identified by the sensor ID. The FPGA ID is ID information regarding an ID of the conversion circuit 103. The conversion circuit 103 is identified by the FPGA ID. The bit stream is rewrite information for rewriting logic of the FPGA. The bit stream is used for configuration of the FPGA, and the logic of the FPGA is updated based on the bit stream. The device driver is driver information regarding a device driver compatible with the special sensor 102. The special sensor 102 is controlled by the processor 104 based on the device driver. The signal processing software is software information regarding signal processing software compatible with the special sensor 102. The processor 104 executes various types of processing based on the signal processing software. The signal processing software may include various types of software.

Here, in the example of FIG. 10, in a case where the sensor ID is “AAAA” and the FPGA ID is “F0001”, the corresponding bit stream, device driver, and signal processing software (SW) are “aaaa0001.bit”, “aaaa.ko”, and “aaaa0001.so”, respectively. In this case, if a sensor ID and an FPGA ID included in the configuration file Fa are “AAAA” and “F0001”, respectively, information indicating that the corresponding bit stream, device driver, and signal processing software (SW) are “aaaa0001.bit”, “aaaa.ko”, and “aaaa0001.so”, respectively, is selected, and these various types of information (for example, the bit stream, the device driver, and the signal processing software) are transmitted as sensor control information to the camera 100A.

Returning to FIG. 9, the network is, for example, a communication network such as a local area network (LAN), a wide area network (WAN), a cellular network, a fixed telephone network, a regional Internet protocol (IP) network, or the Internet. The network may include a wired network or a wireless network. In addition, the network may include a core network. The core network is, for example, an evolved packet core (EPC) or a 5G core network (5GC). In addition, the network may include a data network other than the core network. For example, the data network may be a service network of a telecommunications carrier, for example, an IP multimedia subsystem (IMS) network. In addition, the data network may also be a private network, such as an intra-company network.

In addition, as a radio access technology (RAT), long term evolution (LTE), new radio (NR), Wi-Fi (registered trademark), Bluetooth (registered trademark), or the like can be used. Several types of these radio access technologies may be used, for example, NR and Wi-Fi may be used, and LTE and NR may be used. LTE and NR are types of cellular communication technologies and enable mobile communication by arranging a plurality of areas covered by base stations in a cell form.

The terminal device 160 is, for example, a personal computer (notebook personal computer or desktop personal computer). Note that, as the terminal device, for example, a terminal such as a smart device (a smartphone, a tablet, or the like) or a personal digital assistant (PDA) may be used other than the personal computer. The terminal device 160 is used by, for example, a maintenance worker. As an example, the maintenance worker replaces or newly adds the special sensor 102 of the camera 100A. At this time, the maintenance worker connects the terminal device 160 to the camera 100A and performs an input operation on the terminal device 160 to issue an instruction (command) from the terminal device 160 to the processor 104. Note that the terminal device 160 is connected to the camera 100A via, for example, a universal serial bus (USB) or the like.

### 1-5-2. First Processing Example of Information Processing System

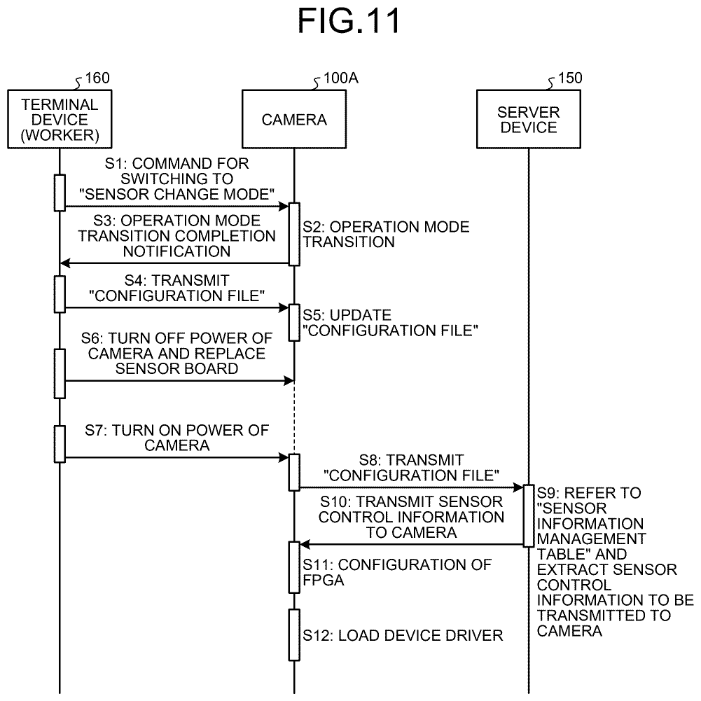

A first processing example of the information processing system 1A according to the present embodiment will be described with reference to FIG. 11. FIG. 11 is a view for describing a flow of the first processing example of the information processing system 1A according to the present embodiment.

As illustrated in FIG. 11, in step S1, the terminal device 160 transmits a command for switching to a “sensor change mode” to the camera 100A via terminal software connected to the camera 100A according to an input operation of a worker (for example, a maintenance worker). In response to reception of the command for switching, the camera 100A transitions an operation mode to the “sensor change mode” in step S2, and transmits an operation mode transition completion notification to the terminal device 160 in step S3.

In step S4, in response to reception of the operation mode transition completion, the terminal device 160 transmits a “configuration file” suitable for a sensor (for example, the special sensor 102) to be newly connected to the camera 100A via the terminal software connected to the camera 100A. In step S5, the camera 100A updates the “configuration file” in the memory 104A based on the received “configuration file”. The “configuration file” is, for example, the configuration file Fa. Note that the worker turns off the power of the camera 100A, reconnects the new sensor board 110 to replace the sensor board 110 in step S6. After the replacement is completed, the worker turns on the camera 100A in step S7.

The camera 100A is activated in the “sensor change mode”, and transmits the “configuration file” to the server device 150 in step S8. The server device 150 refers to the sensor information management table Fb managed on the server device 150 side based on information of the received “configuration file”, extracts sensor control information (for example, bit streams, device drivers, and signal processing software corresponding to the number of sensors connected to the camera 100A) to be transmitted to the camera 100A in step S9, and transmits the extracted sensor control information to the camera 100A in step S10.

In step S11, the camera 100A performs configuration of the conversion circuit 103 (configuration of the FPGA) using a bit stream transmitted from the server device 150 by the processor 104. Furthermore, in step S12, the camera 100A loads a transmitted device driver by the processor 104. Along with this loading, the camera 100A processes RAW data acquired from the special sensor 102 using signal processing software transmitted simultaneously with the device driver by the processor 104 and utilizes the processed RAW data on an application software side.

According to such a first processing example, even in a case where the special sensor 102 is replaced or added and the like, a bit stream of the conversion circuit 103 can be rewritten from an external device such as the server device 150, so that the conversion circuit 103 can correspond to various types of the special sensors 102. In addition, since the processor 104 can also update a device driver or acquire signal processing software, it is possible to support various types of the special sensors 102.

### 1-5-3. Second Configuration Example of Information Processing System

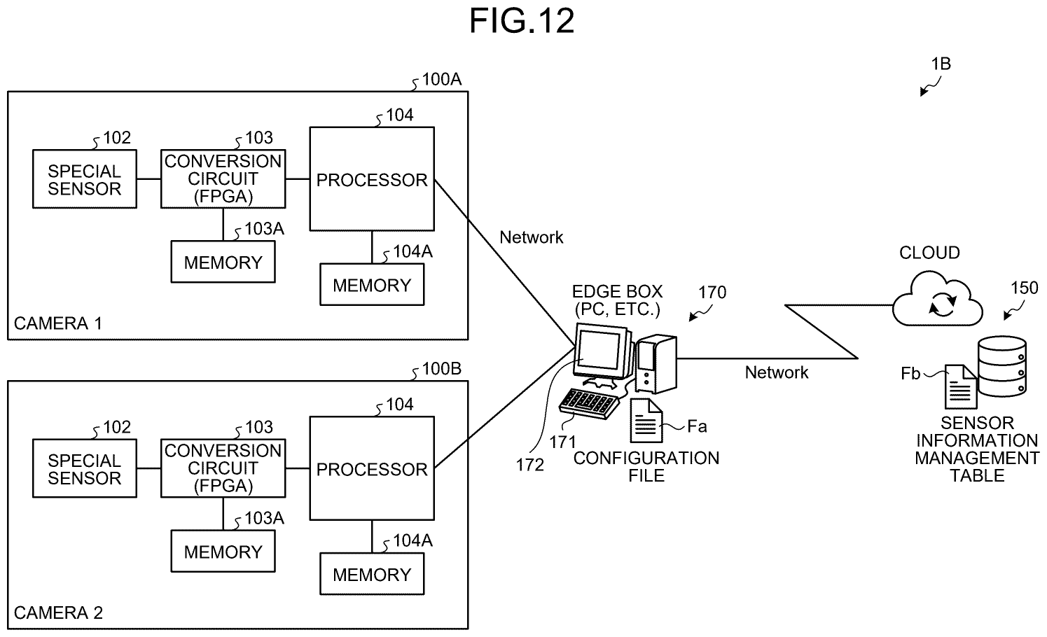

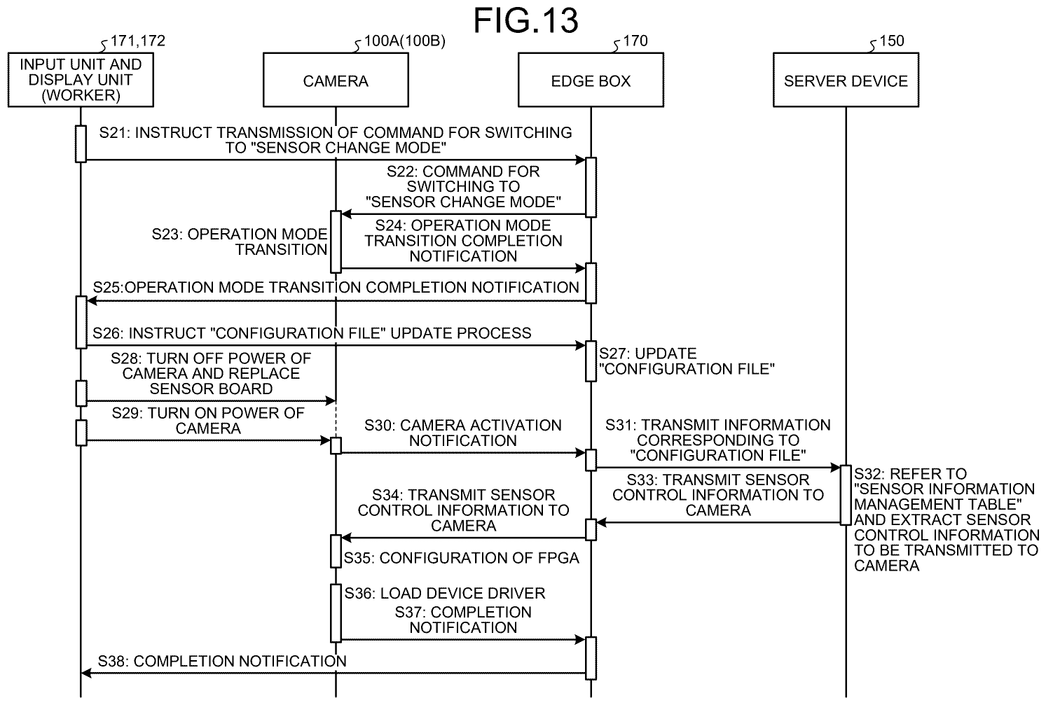

A second configuration example of an information processing system 1B according to the present embodiment will be described with reference to FIG. 12. FIG. 12 is a diagram illustrating the second configuration example of the information processing system 1B according to the present embodiment.

As illustrated in FIG. 12, the information processing system 1B includes a plurality of cameras 100A and 100B, the server device 150, and an edge box (edge terminal device) 170. Each of the cameras 100A and 100B is an imaging device to which the above-described information processing device 100 is applied.

Note that the cameras 100A and 100B, the server device 150, and the sensor information management table Fb according to the example of FIG. 12 are basically the same as those in the example of FIG. 9, and thus the description thereof will be omitted. Note that the configuration file Fa is stored in the edge box 170 instead of the individual memories 104A of the cameras 100A and 100B.

The edge box 170 is, for example, a personal computer (notebook personal computer or desktop personal computer) including an input unit 171, a display unit 172, and the like. The input unit 171 is realized by, for example, a keyboard, a mouse, or the like. In addition, the display unit 172 is realized by, for example, a liquid crystal display (LCD), an organic electroluminescence (EL) panel, or the like. Note that, as the edge box 170, various terminals other than the personal computer may be used.

The edge box 170 is used by, for example, a maintenance worker. As an example, the maintenance worker directly adds or reduces the number of cameras such as the cameras 100A and 100B, or replaces or adds the special sensor 102 of each of the cameras 100A and 100B. At the time of replacement or addition, the maintenance worker performs an input operation on the input unit 171 of the edge box 170 to issue an instruction (command) from the edge box 170 to each of the cameras 100A and 100B.

In addition, the edge box 170 stores, for example, information such as the configuration file Fa. The configuration file Fa includes, for example, the number of cameras to be connected, information for each camera, and the like. The information for each camera includes information such as the number of sensors to be connected, a sensor ID for each channel, and an “FPGA ID” for each channel. In addition, the edge box 170 may execute various types of processing on data (for example, image data) output from each of the individual processors 104 of the cameras 100A and 100B. For example, in a case where the processor 104 executes an application that generates an image or the like, the edge box 170 may execute subsequent processing. Examples of the application that realizes the subsequent processing include an application that detects an object. This object detection application may be realized by, for example, artificial intelligence (AI).

Note that the edge box 170 and the cameras 100A and 100B mutually have communication units and the like, and thus can communicate with each other via the network. In the example of FIG. 12, the two cameras 100A and 100B are connected to the edge box 170 via the network.

### 1-5-4. Second Processing Example of Information Processing System

A second processing example of the information processing system 1B according to the present embodiment will be described with reference to FIG. 13. FIG. 13 is a view for describing a flow of the second processing example of the information processing system 1B according to the present embodiment. Although the camera 100A will be described as an example in the following description, processing related to the camera 100B is similar.

As illustrated in FIG. 13, the input unit 171 instructs the edge box 170 to transmit a command for switching to a “sensor change mode” in step S21 according to an input operation of a worker (for example, a maintenance worker). In response to reception of the instruction of the command for switching, the edge box 170 transmits the command for switching to the “sensor change mode” to the camera 100A via terminal software connected to the camera 100A in step S22.

The camera 100A transitions an operation mode to the “sensor change mode” in step S23, and transmits an operation mode transition completion notification to the edge box 170 in step S24. In step S25, the edge box 170 transmits the operation mode transition completion notification to the display unit 172. The display unit 172 notifies the worker of the operation mode transition completion through a display. The worker views the display unit 172 to grasp the operation mode transition completion, and performs an input operation on the input unit 171. In step S26, the input unit 171 instructs the edge box 170 to perform a “configuration file” update process according to the input operation of the worker. In step S27, the edge box 170 updates the “configuration file” according to the instruction of the update process. The “configuration file” is, for example, the configuration file Fa.

Note that the worker turns off the power of the camera 100A, reconnects the new sensor board 110 to replace the sensor board 110 in step S28. After the replacement is completed, the worker turns on the camera 100A in step S29. In step S30, the camera 100A transmits a camera activation notification to the edge box 170.

In step S31, the edge box 170 transmits information corresponding to the “configuration file” (for example, configuration file information of the corresponding camera 100A). The server device 150 refers to the sensor information management table Fb managed on the server device 150 side based on the received information corresponding to the “configuration file”, extracts sensor control information (for example, bit streams, device drivers, and signal processing software corresponding to the number of sensors connected to the camera 100A) to be transmitted to the camera 100A in step S32, and transmits the extracted sensor control information to the edge box 170 in step S33. In step S34, the edge box 170 transmits the sensor control information transmitted from the server device 150 to the corresponding camera 100A.

In step S35, the camera 100A performs configuration of the conversion circuit 103 (configuration of the FPGA) using a bit stream transmitted from the server device 150 via the edge box 170 by the processor 104. Furthermore, in step S36, the camera 100A loads a transmitted device driver by the processor 104. Along with this loading, the camera 100A processes RAW data acquired from the special sensor 102 using signal processing software transmitted simultaneously with the device driver by the processor 104 and utilizes the processed RAW data on an application software side.

In step S37, the camera 100A transmits a completion notification to the edge box 170. In step S38, the edge box 170 transmits the completion notification to the display unit 172. The display unit 172 notifies the worker of the completion through display.

According to such a second processing example, similarly to the first processing example, even in a case where the special sensor 102 is replaced or added, a case where the camera 100A (or the camera 100B) is replaced or added, and the like, a bit stream of the conversion circuit 103 can be rewritten from an external device such as the server device 150, so that the conversion circuit 103 can correspond to various special sensors. In addition, since the processor 104 can also update a device driver or acquire signal processing software, it is possible to support various types of the special sensors 102.

### 1-6. Action and Effect

As described above, according to the present embodiment, the information processing device 100 includes the special sensor 102, which is an example of a sensor that acquires image generation data, and the conversion circuit 103 that converts data (image generation data) based on a predetermined interface or data format acquired by the special sensor 102 into data (image generation data) based on another interface or data format compatible with the processor 104. As a result, the data based on the predetermined interface or data format acquired by the special sensor 102 is converted into the data based on another interface or data format compatible with the processor 104, so that the processor 104 can execute desired processing on the data acquired by the special sensor 102.

In addition, the information processing device 100 may further include the processor 104 that processes the data converted by the conversion circuit 103. This makes it possible to process the data in the information processing device 100.

In addition, the conversion circuit 103 is a circuit in which logic can be rewritten, and the processor 104 may rewrite the logic of the conversion circuit 103 according to the type of the special sensor 102. This makes it possible to rewrite the logic of the conversion circuit 103 according to the type of the special sensor 102.

In addition, the information processing device 100 may further include the memory 103A that stores rewrite information (for example, a bit stream) for rewriting the logic of the conversion circuit 103, and the processor 104 may rewrite the logic of the conversion circuit 103 based on the rewrite information. This makes it possible to reliably rewrite the logic of the conversion circuit 103.

In addition, the memory 104A that stores configuration information (for example, the configuration file Fa) regarding the special sensor 102 and the conversion circuit 103 may be further included. This makes it possible to use the configuration information.

In addition, the information processing device 100 further includes the sensor board 110 on which the special sensor 102 is provided and the circuit board 111 on which the conversion circuit 103 is provided, the sensor board 110 and the circuit board 111 are formed to be detachably attached, and the special sensor 102 and the conversion circuit 103 are formed to be electrically connected in a state where the sensor board 110 and the circuit board 111 are attached. This makes it possible to detach and attach the sensor board 110 and the circuit board 111, and thus the special sensor 102, the circuit board 111, and the like can be replaced.

In addition, the sensor board 110 and the circuit board 111 may be stacked. This makes it possible to reduce a space in the planar direction required to install the sensor board 110 and the circuit board 111.

In addition, the sensor board 110 and the circuit board 111 may have connection connectors 110a and 111a based on the same interface (for example, MIPI), respectively, and the circuit board 111 may have the output connector 111b that is for outputting data from the conversion circuit 103 and based on an interface (for example, SubLVDS) different from the above-described interface. As a result, the data based on the predetermined interface acquired by the special sensor 102 can be converted into data based on the interface compatible with the processor 104 and output.

In addition, in the above-described configuration including the connection connectors 110a and 111a and the output connector 111b, the connection connectors 110a and 111a of the sensor board 110 and the circuit board 111 may be coupling connectors that couple the sensor board 110 and the circuit board 111. This makes it possible to couple the sensor board 110 and the circuit board 111, so that the sensor board 110 and the circuit board 111 can be integrated.

In addition, the sensor board 110 and the circuit board 111 may have connection connectors 110a and 111a based on the same interface (for example, MIPI), respectively, and the circuit board 111 may have an output connector 111c for outputting data from the conversion circuit 103 based on the same interface (for example, MIPI) as the above-described interface. As a result, the data based on the predetermined data format acquired by the special sensor 102 can be converted into data based on the data format compatible with the processor 104 and output.

In addition, also in the above-described configuration including the connection connectors 110a and 111a and the output connector 111c, the connection connectors 110a and 111a of the sensor board 110 and the circuit board 111 may be coupling connectors that couple the sensor board 110 and the circuit board 111. This makes it possible to couple the sensor board 110 and the circuit board 111, so that the sensor board 110 and the circuit board 111 can be integrated.

In addition, the information processing system 1A (or 1B) includes the special sensor 102, which is an example of a sensor that acquires image generation data, the conversion circuit 103 that converts data based on a predetermined interface or data format acquired by the special sensor 102 into data based on another interface or data format compatible with the processor 104, the processor 104 that processes the data converted by the conversion circuit 103, and the server device 150 that manages data to be used by the conversion circuit 103 or the processor 104. As a result, the data based on the predetermined interface or data format acquired by the special sensor 102 is converted into the data based on another interface or data format compatible with the processor 104, so that the processor 104 can execute desired processing on the data acquired by the special sensor 102.

In addition, in the information processing system 1A (or 1B), the conversion circuit 103 is a circuit in which logic can be rewritten, and the processor 104 may rewrite the logic of the conversion circuit 103 according to the type of the special sensor 102. This makes it possible to rewrite the logic of the conversion circuit 103 according to the type of the special sensor 102.

In addition, the server device 150 may store, as data, management information (for example, the sensor information management table Fb) for managing sensor information compatible with the special sensor 102, and the processor 104 may rewrite the logic of the conversion circuit 103 based on the management information. This makes it possible to reliably rewrite the logic of the conversion circuit 103.

In addition, the sensor information may include rewrite information (for example, a bit stream) for rewriting the logic of the conversion circuit 103, and the memory 103A that stores the rewrite information may be further included, and the processor 104 may rewrite the logic of the conversion circuit 103 based on the rewrite information. This makes it possible to reliably rewrite the logic of the conversion circuit 103.

In addition, the information processing system 1A (or 1B) may further include the memory 104A that stores configuration information (for example, the configuration file Fa) regarding the special sensor 102 and the conversion circuit 103, the server device 150 may select sensor information from management information (for example, the sensor information management table Fb) based on the configuration information, and the processor 104 may rewrite logic of the conversion circuit 103 based on the sensor information selected by the server device 150. This makes it possible to reliably rewrite the logic of the conversion circuit 103.

In addition, the sensor information includes driver information regarding a device driver compatible with the special sensor 102, and the processor 104 may control the special sensor 102 based on the driver information. As a result, the processor 104 can reliably control the special sensor 102.

In addition, the sensor information may include software information regarding signal processing software compatible with the special sensor 102, and the processor 104 may process the data converted by the conversion circuit 103 based on the software information. As a result, the processor 104 can reliably process the data converted by the conversion circuit 103.

Note that the information processing device 100 and the information processing system 1A (or 1C) described above are realized as a device and a system including the conversion circuit 103 described above, but other than the device or the system, for example, an information processing circuit or an information processing method that performs the conversion processing described above may be realized.

### 2. Application Example

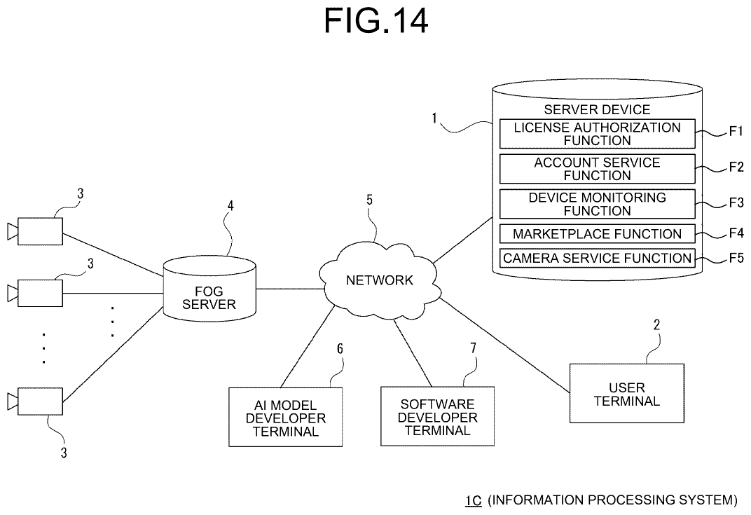

An information processing system 1C to which the information processing device 100, the information processing system 1A, or the information processing system 1B according to the above-described embodiment (including modifications) is applied will be described with reference to FIGS. 14 to 32.

### 2-1. Information Processing System

### 2-1-1. Overall Configuration of System

FIG. 14 is a diagram illustrating a configuration example of the information processing system 1C according to the present embodiment.

As illustrated in FIG. 14, the information processing system 1C includes a server device 1, one or a plurality of user terminals 2, a plurality of cameras 3, a FOG server 4, an artificial intelligence (AI) model developer terminal 6, and a software developer terminal 7. In this example, the server device 1 is configured to be capable of performing mutual communication with the user terminal 2, the FOG server 4, the AI model developer terminal 6, and the software developer terminal 7 via a network 5 such as the Internet.

Here, for example, each of the cameras 3 corresponds to the camera 100A, 100B, or the like, and the FOG server 4 or the server device 1 corresponds to the server device 150.

The server device 1, the user terminal 2, the FOG server 4, the AI model developer terminal 6, and the software developer terminal 7 are configured as information processing devices each including a microcomputer that includes a CPU, a ROM, and a RAM.

Here, the user terminal 2 is an information processing device expected to be used by a user who receives a service using the information processing system 1C. In addition, the server device 1 is an information processing device expected to be used by a service provider.

Each of the cameras 3 includes, for example, an image sensor such as a charge coupled device (CCD) image sensor or a complementary metal oxide semiconductor (CMOS) image sensor, and captures an image of a subject to obtain image data (captured image data) as digital data. In addition, as will be described below, each of the cameras 3 also has a function of performing image processing (AI image processing), such as image recognition processing using an AI model, on the captured image.

Each of the cameras 3 is configured to be capable of data communication with the FOG server 4, and can transmit various types of data, such as processing result information indicating a result of the image processing using the AI model, to the FOG server 4 and receive various types of data from the FOG server 4, for example.

Here, the information processing system 1C illustrated in FIG. 14 is expected to be used such that the FOG server 4 or the server device 1 generates analysis information of a subject based on processing result information obtained by AI image processing of each of the cameras 3, and the generated analysis information is browsed by the user via the user terminal 2. In this case, as applications of the respective cameras 3, applications as various monitoring cameras are conceivable. For example, there are applications as indoor monitoring cameras for a store, an office, a house, and the like, monitoring cameras (including a traffic monitoring camera and the like) for monitoring the outdoors such as a parking lot, a street, and the like, monitoring cameras for manufacturing lines in factory automation (FA) and industrial automation (IA), monitoring cameras for monitoring of the inside and the outside of a vehicle, and the like.

For example, for the application as monitoring cameras in a store, it is conceivable to arrange the plurality of cameras 3 at predetermined positions in the store such that a user can confirm customer groups (gender, an age group, and the like) of customers and behaviors (traffic flows) in the store, and the like. In that case, as the above-described analysis information, it is conceivable to generate information on the customer groups of the customers, information on the traffic flows in the store, information on a congestion state in a checkout register (for example, information on a waiting time at the checkout register), and the like. Alternatively, for the application as traffic monitoring cameras, it is conceivable to arrange the cameras 3 respectively at positions near roads such that a user can recognize information such as a number (vehicle number), a vehicle color, and a vehicle type regarding a passing vehicle. In that case, it is conceivable to generate these pieces of information such as the number, the vehicle color, and the vehicle type as the above-described analysis information.

In addition, in a case where a traffic monitoring camera is used in a parking lot, it is conceivable to arrange the camera so as to be capable of monitoring each parked vehicle, monitor whether a suspicious person performing a suspicious behavior is present around each vehicle, and if there is a suspicious person, notify the presence of the suspicious person, an attribute (gender, an age group, clothes, and the like) of the suspicious person, and the like. Furthermore, it is also conceivable to monitor a vacant space in a town or a parking lot and notify a user of a location of the space where a vehicle can be parked.

The FOG server 4 is expected to be arranged for each monitoring target, for example, arranged in a store, which is the monitoring target, together with each of the cameras 3 in the above-described application for monitoring the store. When the FOG server 4 is provided for each monitoring target such as the store in this manner, it is not necessary for the server device 1 to directly receive transmission data from the plurality of cameras 3 in the monitoring target, and a processing load of the server device 1 can be reduced.

Note that, in a case where there are a plurality of stores as monitoring targets and all the stores are stores that belong to the same affiliation, one FOG server 4 may be provided for the plurality of stores, instead of being provided for each store. That is, the FOG server 4 is not limited to be provided for each monitoring target, and the single FOG server 4 can be provided for a plurality of monitoring targets.

Note that, in a case where the server device 1 or each of the cameras 3 can serve a function of the FOG server 4 due to a reason that the server device 1 or each of the cameras 3 has processing capability, the FOG server 4 may be omitted in the information processing system 1C, each of the cameras 3 may be directly connected to the network 5, and the server device 1 may directly receive transmission data from the plurality of cameras 3.

The server device 1 is configured as an information processing device having a function of performing the overall management of the information processing system 1C. As illustrated in the drawing, the server device 1 has a license authorization function F1, an account service function F2, a device monitoring function F3, a marketplace function F4, and a camera service function F5 as functions related to the management of the information processing system 1C.

The license authorization function F1 is a function of performing processing related to various types of authentication. Specifically, in the license authorization function F1, processing related to device authentication of each of the cameras 3 and processing related to authentication of each of an AI model, software, and firmware used in the camera 3 are performed.

Here, the above-described software means software necessary for appropriately realizing image processing using an AI model in the camera 3. In order to appropriately perform AI image processing based on a captured image and transmit a result of the AI image processing to the FOG server 4 or the server device 1 in an appropriate form, it is required to control data input with respect to the AI model and appropriately process output data of the AI model. The above-described software is software including peripheral processing necessary for appropriately realizing the image processing using the AI model. Such software can be rephrased as software for realizing a desired function using the AI model, and thus is hereinafter referred to as “AI-using software”.

Note that AI-using software using two or more AI models is also conceivable without being limited to one using only one AI model. For example, there may be AI-using software having a flow of processing in which an image processing result (image data), obtained by an AI model that executes AI image processing on a captured image as input data, is input to another AI model to execute second AI image processing.

In the license authorization function F1, regarding the authentication of the cameras 3, processing of issuing a device ID for each of the cameras 3 is performed when the cameras 3 are connected via the network 5.

In addition, regarding the authentication of an AI model and software, processing of issuing unique IDs (AI model ID and software ID) is performed for an AI model and AI-using software for which registration has been applied from the AI model developer terminal 6 and the software developer terminal 7, respectively.

In addition, in the license authorization function F1, processing of issuing various keys, certificates, and the like for enabling secure communication between the server device 1 and each of the cameras 3, the AI model developer terminal 6, and the software developer terminal 7 to manufacturers of the camera 3 (particularly, manufacturers of image sensors 30 to be described below), an AI model developer, and a software developer is performed, and processing for stopping or updating certification validity is also performed.

Furthermore, in the license authorization function F1, processing of associating the camera 3 (the above-described device ID) purchased by a user with a user ID is also performed when registration of the user (registration of account information accompanied by issuance of the user ID) is performed by the account service function F2 to be described hereinafter.

The account service function F2 is a function of generating and managing account information of a user. The account service function F2 receives an input of user information, and generates account information based on the input user information (generates the account information including at least a user ID and password information).

In addition, registration processing (registration of account information) for an AI model developer and a developer of AI-using software (hereinafter, also abbreviated as “software developer”) is also performed in the account service function F2.

The device monitoring function F3 is a function of performing processing for monitoring use states of the cameras 3. For example, various elements related to the use states of the cameras 3 such as use locations of the cameras 3, an output frequency of output data of AI image processing, and a free space of a memory used for the AI image processing are monitored.

The marketplace function F4 is a function for selling an AI model and AI-using software. For example, a user can purchase AI-using software and an AI model used by the AI-using software via a sales WEB site (sales site) provided by the marketplace function F4. In addition, a software developer can purchase an AI model for creating AI-using software via the sales site.

The camera service function F5 is a function for providing a user with a service related to use of the cameras 3. As one of the camera service functions F5, for example, a function related to generation of the above-described analysis information can be exemplified. That is, it is the function of performing processing for generating the analysis information of the subject based on the processing result information of the AI image processing in the camera 3 and causing the user to browse the generated analysis information via the user terminal 2.

In addition, the camera service function F5 includes an imaging setting search function in this example. Specifically, this imaging setting search function is a function of acquiring processing result information indicating a result of AI image processing from the camera 3, and searching for imaging setting information of the camera 3 using AI based on the acquired processing result information. Here, the term “imaging setting information” broadly means setting information related to an imaging operation for obtaining a captured image. Specifically, optical settings such as focus and aperture, settings related to an operation of reading a captured image signal such as a frame rate, an exposure time, and a gain, and settings related to image signal processing on the read captured image signal such as gamma correction processing, noise reduction processing, and super-resolution processing are broadly included.

In addition, the camera service function F5 also includes an AI model search function. The AI model search function is a function of acquiring processing result information indicating a result of AI image processing from the camera 3, and searching for an optimal AI model used for AI image processing in the camera 3 using AI based on the acquired processing result information. The term “AI model search” referred to herein means, for example, processing of optimizing various types of processing parameters such as a weighting factor, setting information (for example, including information on a kernel size) related to a neural network structure, and the like in a case where AI image processing is realized by a convolutional neural network (CNN) including a convolution operation.

In addition, the camera service function F5 also includes a relearning function (retraining function) of an AI model. For example, when an AI model relearned using a dark image from the camera 3 arranged in a store is deployed to this camera 3, an image recognition rate or the like for an image captured in a dark location can be improved. In addition, when an AI model relearned using a bright image from the camera 3 arranged outside a store is deployed to this camera 3, an image recognition rate or the like for an image captured in a bright location can be improved. That is, a user can always obtain optimized processing result information by redeploying a retrained AI model to the camera 3. Note that relearning processing of an AI model may be selected as an option by the user on a marketplace, for example.

Since the imaging setting search function and the AI model search function as described above are provided, for example, it is possible to achieve imaging settings that make a processing result of AI image processing such as image recognition favorable, and to perform AI image processing using an appropriate AI model according to an actual use environment.

Here, the configuration in which the license authorization function F1, the account service function F2, the device monitoring function F3, the marketplace function F4, and the camera service function F5 are realized by the server device 1 alone has been exemplified in the above description, but it is also possible to adopt a configuration in which these functions are shared and realized by a plurality of information processing devices. For example, it is conceivable to adopt a configuration in which each one of the above-described functions is performed by one information processing device. Alternatively, a plurality of information processing devices may share and perform a single function among the above-described functions.

In FIG. 14, the AI model developer terminal 6 is an information processing device used by a developer of an AI model. In addition, the software developer terminal 7 is an information processing device used by a developer of AI-using software.

### 2-1-2. Registration of AI Model and AI Software

As understood from the above description, in the information processing system 1C according to the embodiment, the camera 3 performs image processing using an AI model and AI-using software, and the server device 1 realizes an advanced application function using information of the image processing on the camera 3 side.

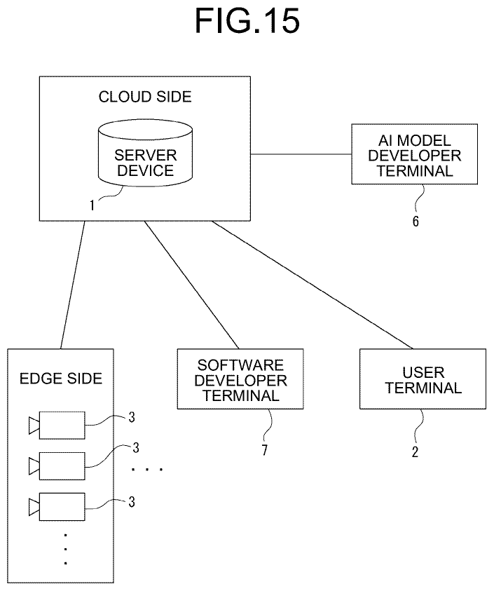

Here, an example of a method of registering an AI model and AI-using software in the server device 1 (or including the FOG server 4) as a cloud side will be described with reference to FIG. 15. Note that, although the FOG server 4 is not illustrated in FIG. 15, the FOG server 4 may bear some of functions on the cloud side or may bear some of functions on an edge side (the camera 3 side).

On the cloud side, for example, training data sets for performing learning using AI are prepared in the server device 1. An AI model developer communicates with the server device 1 using the AI model developer terminal 6, and downloads these training data sets. At this time, the training data sets may be provided for a fee. In that case, the training data sets can be sold to the AI model developer by the above-described marketplace function F4 prepared as a function on the cloud side.

After developing an AI model using the training data sets, the AI model developer registers the developed AI model in the marketplace (the sales site provided by the marketplace function F4) using the AI model developer terminal 6. At this time, an incentive may be paid to the AI model developer according to download of the AI model.

In addition, a software developer downloads the AI model from the marketplace using the software developer terminal 7, and develops AI-using software. At this time, the incentive may be paid to the AI model developer as described above.

The software developer registers the developed AI-using software in the marketplace using the software developer terminal 7. When the AI-using software registered in the marketplace in this manner is downloaded, an incentive may be paid to the software developer.

Note that the correspondence relationship between the AI-using software registered by the software developer and the AI model used by the AI-using software is managed in the marketplace (server device 1).

A user can purchase the AI-using software and the AI model used by the AI-using software from the marketplace using the user terminal 2. The incentive may be paid to the AI model developer according to the purchase (download).

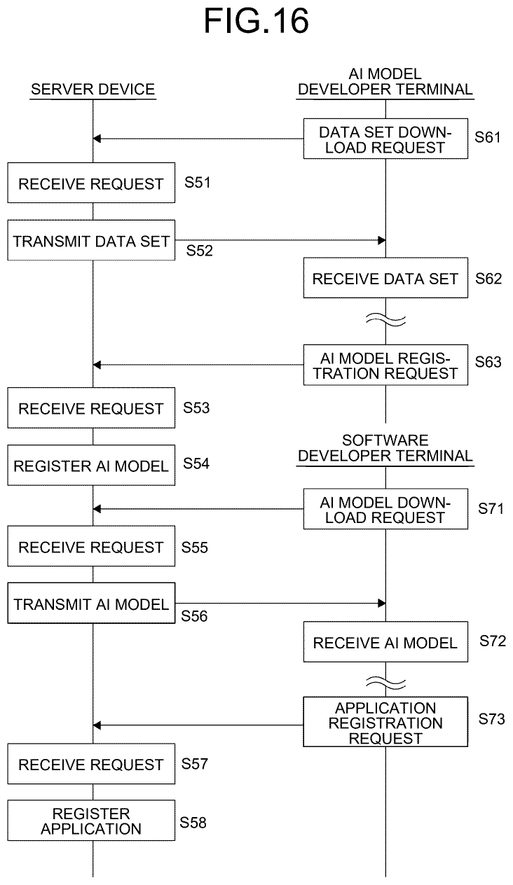

For confirmation, a flow of the above-described processing is illustrated in a flowchart of FIG. 16.

In FIG. 16, in step S21, an AI model developer terminal 6 transmits a request for downloading a data set (training data set) to the server device 1. Such a download request is made, for example, as the AI model developer browses a list of data sets registered in the marketplace using the AI model developer terminal 6 having a display unit including an LCD, an organic EL panel, or the like and selects a desired data set.

In response to this, the server device 1 receives the request in step S11, and transmits the data set requested in step S12 to the AI model developer terminal 6.

The AI model developer terminal 6 receives the data set in step S22. As a result, the AI model developer can develop an AI model using the data set.

After the AI model developer finishes the development of the AI model, when the AI model developer performs an operation for registering the developed AI model in the marketplace (for example, designating a name of the AI model, an address at which the AI model is placed, or the like), the AI model developer terminal 6 transmits a request for registering the AI model in the marketplace to the server device 1 in step S23.

In response to this, the server device 1 receives such a registration request in step S13, and performs an AI model registration process in step S14. This makes it possible to display the AI model on the marketplace, for example. As a result, a user other than the AI model developer can download the AI model from the marketplace.

For example, a software developer who desires to develop software using AI browses a list of AI models registered in the marketplace using the software developer terminal 7. In response to an operation (for example, operation of selecting one of the AI models on the marketplace) of the software developer, the software developer terminal 7 transmits a request for downloading the selected AI model to the server device 1 in step S31.

The server device 1 receives the request in step S15, and transmits the AI model to the software developer terminal 7 in step S16.

The software developer terminal 7 receives the AI model in step S32. As a result, the software developer can develop AI-using software using the AI model.

When the software developer finishes the development of the AI-using software, and then performs an operation (for example, operation of designating a name of the AI-using software, an address at which the AI model is placed, or the like) for registering the AI-using software in the marketplace, the software developer terminal 7 transmits a request for registering the AI-using software to the server device 1 in step S33.

The server device 1 receives such a registration request in step S17, and registers the AI-using software in step S18. This makes it possible to display the AI-using software on the marketplace, for example, and as a result, a user can select and download the AI-using software (and the AI model used by the AI-using software) on the marketplace.

Here, for use of the purchased AI-using software and AI model in the camera 3, the user requests the server device 1 to install the AI-using software and the AI model to be usable in the camera 3.

Hereinafter, to install the AI-using software and the AI model to be usable in the camera 3 as described above is referred to as “deployment”.

When the purchased AI-using software and the AI model are deployed in the camera 3, processing using the AI model can be performed in the camera 3, and not only an image can be captured, but also detection of a customer, detection of a vehicle, or the like using the AI model can be performed.

Cloud applications are deployed in the server device 1 as the cloud side, and each user can use the cloud applications via the network 5. Then, among the cloud applications, an application that performs the above-described analysis processing and the like are prepared. Examples thereof include an application that analyzes traffic flows of customers using attribute information and image information (for example, person extraction images or the like) of the customers.

A user can analyze traffic flows of customers of the user's own store and browse an analysis result by utilizing the cloud application for traffic flow analysis using the user terminal 2. The analysis result is presented, for example, by graphically presenting the traffic flows of the customers on a map of the store. The result of the traffic flow analysis may be displayed in a format of, for example, a heat map to present the density of the customers or the like. In addition, information on the traffic flows may be sorted and displayed for each attribute information of the customers.

Note that examples of analysis processing include processing of analyzing traffic volume in addition to the above-described traffic flow analysis processing. For example, in the traffic flow analysis processing, processing result information obtained by performing image recognition processing of recognizing a person on each of captured images captured by the camera 3. Then, capturing time of each of the captured images and a pixel area where a person as a detection target is detected are specified based on the processing result information, and a movement of the person in the store is finally grasped to analyze a traffic flow of the target person. In a case where not only the movement of the specific person but also movements of visitors of the store are grasped as a whole, a general traffic flow of the visitors and the like can be analyzed by performing the above processing for each visitor and finally performing statistical processing.

Here, an AI model optimized for each user may be registered in the marketplace on the cloud side. Specifically, for example, captured images captured by the camera 3 arranged in a store managed by a certain user are appropriately uploaded and accumulated on the cloud side, and the server device 1 performs relearning processing of an AI model every time a certain number of the uploaded captured images are accumulated and re-registers the AI model after the relearning in the marketplace.

In addition, in a case where personal information is included in information (for example, image information) uploaded from the camera 3 to the server device 1, data from which information regarding privacy has been deleted from the viewpoint of privacy protection may be uploaded, or data from which information regarding privacy has been deleted may be used by the AI model developer or the software developer.

### 2-1-3. Configuration of Information Processing Device

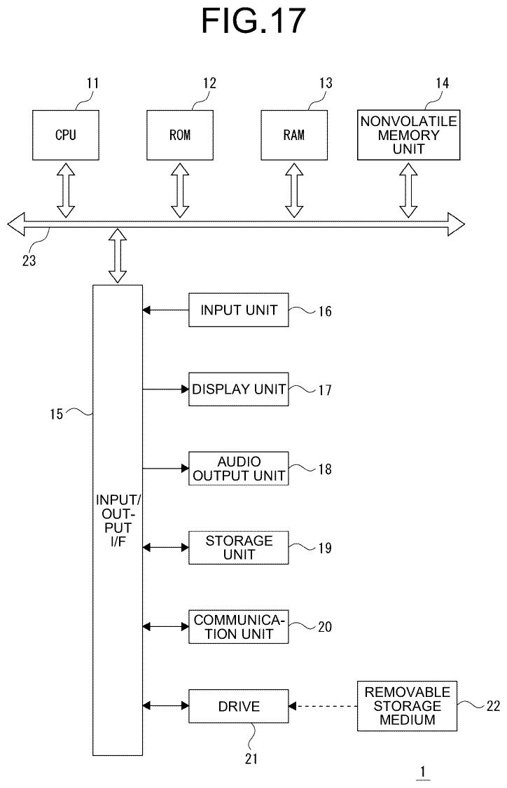

FIG. 17 is a block diagram illustrating an example of a hardware configuration of the server device 1.

As illustrated in FIG. 17, the server device 1 includes a CPU 11. The CPU 11 functions as an arithmetic processing unit that executes various types of processing described so far as processing of the server device 1, and executes the various types of processing according to a program stored in a ROM 12 or a nonvolatile memory unit 14 such as an electrically erasable programmable read-only memory (EEP-ROM), or a program loaded from a storage unit 19 to a RAM 13. In addition, the RAM 13 also appropriately stores data and the like necessary for the CPU 11 to execute various types of processing.

The CPU 11, the ROM 12, the RAM 13, and the nonvolatile memory unit 14 are connected to each other via a bus 23. An input/output interface (I/F) 15 is also connected to the bus 23.

An input unit 16 including an operation element and an operation device is connected to the input/output interface 15. For example, as the input unit 16, various operation elements and operation devices such as a keyboard, a mouse, a key, a dial, a touch panel, a touch pad, and a remote controller are assumed. An operation of a user is detected by the input unit 16, and a signal corresponding to the input operation is interpreted by the CPU 11.

In addition, a display unit 17 including a liquid crystal display (LCD), an organic electro-luminescence (EL) panel, or the like, and an audio output unit 18 including a speaker or the like are integrally or separately connected to the input/output interface 15.

The display unit 17 is used to display various types of information, and is configured using, for example, a display device provided in a housing of a computer device, a separate display device connected to the computer device, or the like.

In addition, the display unit 17 displays an image for various types of image processing, a moving image to be processed, and the like on a display screen based on an instruction from the CPU 11. In addition, the display unit 17 displays various operation menus, icons, messages, and the like, that is, graphical user interfaces (GUIs) based on an instruction from the CPU 11.

The storage unit 19 configured using a hard disk drive (HDD), a solid-state memory, or the like, and a communication unit 20 configured using a modem or the like may be connected to the input/output interface 15.

The communication unit 20 performs communication processing via a transmission path such as the Internet and communication with various apparatuses by wired/wireless communication, bus communication, and the like.

To the input/output interface 15, a drive 21 is also connected as necessary, and a removable storage medium 22 such as a magnetic disk, an optical disk, a magneto-optical disk, or a semiconductor memory is appropriately attached.

The drive 21 enables a data file such as a program used for each process to be read from the removable storage medium 22. The read data file is stored in the storage unit 19, and an image and sound included in the data file are output by the display unit 17 and the audio output unit 18. Furthermore, a computer program and the like read from the removable storage medium 22 are installed into the storage unit 19 as necessary.

In a computer device having the above hardware configuration, for example, software for processing of the present embodiment can be installed via network communication by the communication unit 20 or the removable storage medium 22. Alternatively, the software may be stored in advance in the ROM 12, the storage unit 19, or the like.

The CPU 11 executes processing operations based on various programs, thereby executing necessary information processing and communication processing as the server device 1 described above.

Note that the server device 1 is not limited to a single computer device configured as illustrated in FIG. 17, and may be configured by systematizing a plurality of computer devices. The plurality of computer devices may be systematized by a local area network (LAN) or the like, or may be arranged in remote places by a virtual private network (VPN) or the like using the Internet or the like. The plurality of computer devices may include a computer device as a server group (cloud) that can be used by a cloud computing service.

### 2-1-4. Configuration of Imaging Device

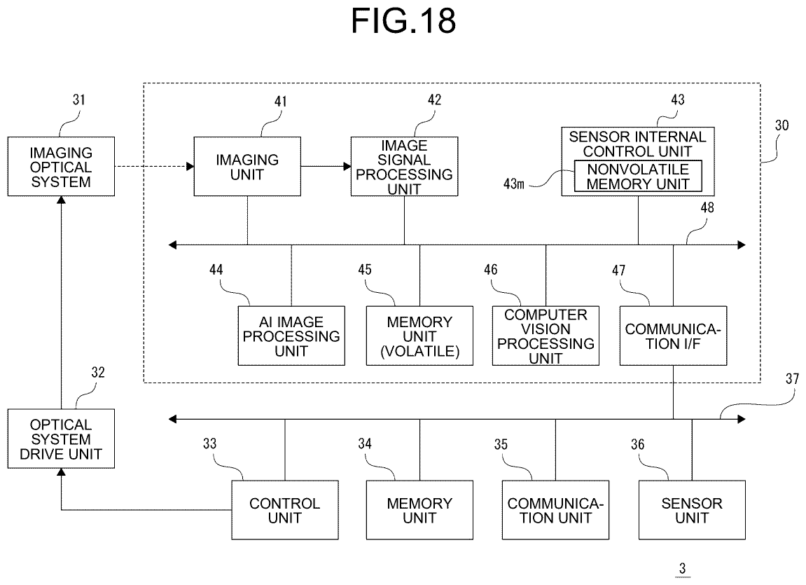

FIG. 18 is a block diagram illustrating a configuration example of the camera 3.

As illustrated in FIG. 18, the camera 3 includes an image sensor 30, an imaging optical system 31, an optical system drive unit 32, a control unit 33, a memory unit 34, a communication unit 35, and a sensor unit 36. The image sensor 30, the control unit 33, the memory unit 34, the communication unit 35, and the sensor unit 36 are connected via a bus 37, and can perform data communication with each other.

The imaging optical system 31 includes lenses such as a cover lens, a zoom lens, and a focus lens, and a diaphragm (iris) mechanism. Light (incident light) from a subject is guided by the imaging optical system 31 and collected on a light receiving surface of the image sensor 30.

The optical system drive unit 32 comprehensively indicates drive units of the zoom lens, the focus lens, and the diaphragm mechanism included in the imaging optical system 31. Specifically, the optical system drive unit 32 includes an actuator for driving each of the zoom lens, the focus lens, and the diaphragm mechanism, and a drive circuit of the actuator.

The control unit 33 includes, for example, a microcomputer including a CPU, a ROM, and a RAM, and performs overall control of the camera 3 by the CPU executing various types of processing according to a program stored in the ROM or a program loaded in the RAM.

In addition, the control unit 33 instructs the optical system drive unit 32 to drive the zoom lens, the focus lens, the diaphragm mechanism, and the like. The optical system drive unit 32 executes movement of the focus lens and the zoom lens, opening and closing of a diaphragm blade of the diaphragm mechanism, and the like according to such drive instructions.

In addition, the control unit 33 controls writing and reading of various types of data to and from the memory unit 34.

The memory unit 34 is a nonvolatile storage device such as an HDD or a flash memory device, for example, and is used for storing data to be used when the control unit 33 executes various types of processing. In addition, the memory unit 34 can also be used as a storage destination (recording destination) of image data output from the image sensor 30.

The control unit 33 performs various types of data communication with an external device via the communication unit 35. The communication unit 35 in this example is configured to be capable of performing data communication with at least the FOG server 4 illustrated in FIG. 1. Alternatively, the communication unit 35 may be configured to be capable of performing communication via the network 5, and may perform data communication with the server device 1.

The sensor unit 36 comprehensively represents sensors other than the image sensor 30 included in the camera 3. Examples of the sensors included in the sensor unit 36 can include a global navigation satellite system (GNSS) sensor and an altitude sensor for detecting a position and an altitude of the camera 3, a temperature sensor for detecting an environmental temperature, and motion sensors such as an acceleration sensor and an angular velocity sensor for detecting motion of the camera 3.

The image sensor 30 is configured as a solid-state imaging element of a CCD type, a CMOS type, or the like, for example, and includes an imaging unit 41, an image signal processing unit 42, a sensor internal control unit 43, an AI image processing unit 44, a memory unit 45, a computer vision processing unit 46, and a communication interface (I/F) 47 which can perform data communication with each other via a bus 48 as illustrated in the drawing.

The imaging unit 41 includes a pixel array unit in which pixels having photoelectric conversion elements such as photodiodes are two-dimensionally arrayed, and a read circuit which reads electric signals obtained by photoelectric conversion from the respective pixels included in the pixel array unit. In this read circuit, for example, correlated double sampling (CDS) processing, automatic gain control (AGC) processing, and the like are executed for the electric signals obtained by photoelectric conversion, and analog/digital (A/D) conversion processing is further executed.

The image signal processing unit 42 performs preprocessing, synchronization processing, YC generation processing, resolution conversion processing, codec processing, and the like on a captured image signal which is digital data after the A/D conversion processing. In the preprocessing, clamp processing of clamping black levels of red (R), green (G), and blue (B) to a predetermined level, correction processing between color channels of R, G, and B, and the like are performed on the captured image signal. In the synchronization processing, color separation processing is performed such that image data for each of the pixels has all color components of R, G, and B. For example, in the case of an imaging element using a color filter having a Bayer array, demosaic processing is performed as the color separation processing. In the YC generation processing, a luminance (Y) signal and a color (C) signal are generated (separated) from image data of R, G, and B. In the resolution conversion processing, resolution conversion processing is executed on image data subjected to various types of signal processing.

In the codec processing, for example, encoding processing for recording or communication and file generation are performed on image data subjected to various types of processing described above. In the codec processing, it is possible to generate a file in a format such as moving picture experts group (MPEG)-2 or H.264 as a file format of a moving image. It is also conceivable to generate a file in a format such as joint photographic experts group (JPEG), tagged image file format (TIFF), or graphics interchange format (GIF) as a still image file.

The sensor internal control unit 43 includes a microcomputer including, for example, a CPU, a ROM, a RAM, and the like, and controls of the entire operation of the image sensor 30. For example, the sensor internal control unit 43 control execution of an imaging operation by issuing an instruction to the imaging unit 41. In addition, execution of processing in the image signal processing unit 42 is also controlled.

The sensor internal control unit 43 includes a nonvolatile memory unit 43m. The nonvolatile memory unit 43m is used for storing data to be used in various types of processing by the CPU of the sensor internal control unit 43.

The AI image processing unit 44 includes a programmable arithmetic processing device such as a CPU, a field programmable gate array (FPGA), or a digital signal processor (DSP), for example, and performs image processing using an AI model on a captured image.

Examples of the image processing (AI image processing) by the AI image processing unit 44 include image recognition processing of recognizing a subject as a specific target such as a person or a vehicle. Alternatively, it is also conceivable to perform object detection processing of detecting the presence or absence of any object regardless of the type of subject as the AI image processing.

A function of the AI image processing by the AI image processing unit 44 can be switched by changing an AI model (algorithm of the AI image processing). Hereinafter, an example in a case where the AI image processing is the image recognition processing will be described.

Although various types of specific image recognition functions can be considered, examples thereof can include types as exemplified below.
Class identification
Semantic segmentation
Person detection
Vehicle detection
Target tracking
Optical character recognition (OCR)

Among the above-described function types, the class identification is a function of identifying a class of a target. The term “class” referred to herein is information indicating a category of an object, and classifies, for example, “person”, “automobile”, “airplane”, “ship”, “truck”, “bird”, “cat”, “dog”, “deer”, “frog”, “horse”, or the like.

The term “target tracking” is a function of tracking a subject as a target, and can be rephrased as a function of obtaining history information of a position of the subject.

The memory unit 45 is configured using a volatile memory, and is used to hold (temporarily store) data necessary for performing the AI image processing by the AI image processing unit 44. Specifically, the memory unit 45 is used to hold AI models and AI-using software, and firmware necessary for performing the AI image processing by the AI image processing unit 44. In addition, the memory unit 45 is also used to hold data to be used in processing performed by the AI image processing unit 44 using the AI models. In this example, the memory unit 45 is also used to hold captured image data processed by the image signal processing unit 42.

The computer vision processing unit 46 performs rule-based image processing as image processing on the captured image data. Examples of the rule-based image processing here include super-resolution processing and the like.

The communication interface 47 is an interface that communicates with the respective units connected via the bus 37, such as the control unit 33 and the memory unit 34 outside the image sensor 30. For example, the communication interface 47 performs communication for acquiring AI-using software, an AI model, and the like used by the AI image processing unit 44 from the outside based on the control of the sensor internal control unit 43. In addition, result information of the AI image processing by the AI image processing unit 44 is output to the outside of the image sensor 30 via the communication interface 47.

### 2-2. System Abuse Prevention Processing as Embodiment

In the present embodiment, the server device 1 performs various types of processing for preventing abuse of the information processing system 1C including the cameras 3 which are AI cameras.

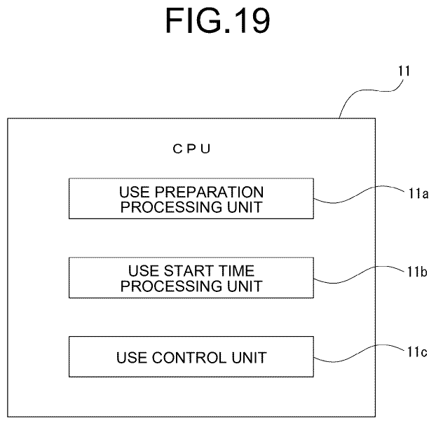

FIG. 19 is a functional block diagram for describing functions related to system abuse prevention included in the CPU 11 of the server device 1.

As illustrated in FIG. 19, the server device 1 has functions as a use preparation processing unit 11a, a use start time processing unit 11b, and a use control unit 11c.

The use preparation processing unit 11a performs processing related to preparation for a user to be provided with a service by the information processing system 1C.

Here, in this example, the user purchases the cameras 3, which are compatible products supporting use in the information processing system 1C, to be provided with the service by the information processing system 1C. At this time, in the camera 3 as the compatible product, information as a master key, used for key generation for performing encryption and decryption of an AI model and AI-using software, is stored in the image sensor 30 at the time of manufacturing the image sensor 30, for example. This master key is stored in a predetermined nonvolatile memory in the image sensor 30, such as the nonvolatile memory unit 43m in the sensor internal control unit 43.

Since the master key used for encryption/decryption of an AI model and AI-using software is stored in the image sensor 30 as described above, the AI model and the AI-using software purchased by a certain user can be decrypted only by the image sensor 30. In other words, it is possible to prevent the other image sensors 30 from fraudulently using the AI model and the AI-using software.

As a procedure before the start of use, the user performs a registration procedure for the purchased cameras 3 and a user account. Specifically, the user connects all the purchased cameras 3, desired to be used, to a designated cloud, that is, the server device 1 via the network in this example. In this state, the user inputs information for registering the cameras 3 and the user account to the server device 1 (the above-described account service function F2) using the user terminal 2.

The use preparation processing unit 11a generates account information of the user based on the information input from the user. Specifically, the account information including at least a user ID and password information is generated.

In addition, the use preparation processing unit 11a not only generates the account information of the user but also performs processing of acquiring sensor IDs (IDs of the image sensors 30), camera IDs (IDs of the cameras 3), region information (installation location information of the cameras 3), hardware type information (for example, a camera that obtains a grayscale image, a camera that obtains a distance image, or the like), memory free space information (free spaces of the memory units 45 in this example), information on an OS version, and the like from the connected cameras 3 using the device monitoring function F3 described above, and associating the acquired information with the generated account information.

In addition, the use preparation processing unit 11a performs processing of assigning IDs to the cameras 3 of the user whose account has been registered using the license authorization function F1 described above. That is, a corresponding device ID is issued for each of the connected cameras 3, and is associated with the camera ID described above, for example. As a result, the server device 1 can identify each of the cameras 3 by the device ID.

Furthermore, the use preparation processing unit 11a performs processing corresponding to purchase acceptance and purchase of the AI-using software and the AI model from the user. That is, when the purchase for the AI-using software and the AI model in the above-described marketplace is accepted and the AI-using software and the AI model are purchased, processing of associating the purchased AI-using software and AI model with the user ID is performed.

In addition, the use preparation processing unit 11a performs encryption processing on the AI-using software and the AI model purchased by the user. In this example, this encryption processing is performed by generating a different key for each of the image sensors 30. Since the encryption is performed using the different key for each of the image sensors 30, it is possible to securely deploy the AI-using software and the AI model.

In this example, a key used to encrypt AI-using software and an AI model is generated by multiplying the above-described master key stored in advance for each of the image sensors 30, the sensor ID, the user ID, and IDs of the AI-using software and AI model to be encrypted (referred to as a “software ID” and an “AI model ID”, respectively).

Note that the master key is prepared in advance by a service operator that manages the server device 1 and stored in the image sensor 30 which is a compatible product. Therefore, the correspondence relationship as to which master key is stored in which image sensor 30 is grasped on the server device 1 side, and can be used to generate the key for each of the image sensors 30 as described above.

The use preparation processing unit 11a encrypts the AI-using software and the AI model purchased by the user using the key generated for each of the image sensors 30 as described above. As a result, pieces of encrypted data respectively for the image sensors 30, encrypted with the mutually different keys, are obtained as encrypted data of the AI-using software and the AI model.

The use start time processing unit 11b performs processing corresponding to the time when the camera 3 starts to be used. Specifically, when the user requests deployment of the purchased AI-using software and AI model to the camera 3, processing for deploying corresponding encrypted data of the AI-using software and the AI model to the corresponding camera 3 is performed. That is, processing is performed to transmit the corresponding encrypted data to the corresponding camera 3 (image sensor 30).

In the image sensor 30 that has received the encrypted data of the AI-using software and the AI model, for example, the sensor internal control unit 43 generates a key using the master key, the sensor ID, the software ID, and the AI model ID, and decrypts the received encrypted data based on the generated key.

Here, the user ID is stored in the image sensor 30 at least in a stage before the AI-using software and the AI model are decrypted. For example, in response to the above-described registration of the account of the user, the server device 1 notifies the image sensor 30 side of the user ID to be stored in the image sensor 30. Alternatively, in a case where there is a condition that it is required to input a user ID to the camera 3 in order to enable use of the camera 3 purchased by a user, the user ID input by the user is stored in the image sensor 30.

In addition, a software ID and an AI model ID are transmitted from the server device 1 side in accordance with deployment, for example, and the sensor internal control unit 43 generates a key using these software ID and AI model ID, the user ID stored in advance as described above, and the master key stored in the nonvolatile memory unit 43m, and decrypts the received encrypted data using the key.

Note that the above description has been made with the example in which the master key is a value unique to the image sensor 30, but a common value can also be assigned to a plurality of the image sensors 30 by assigning a common value for each model of the image sensors 30 or the like. For example, if the master key is unique for each user, purchased AI-using software and AI model can be used even in the newly purchased camera 3 for the same user.

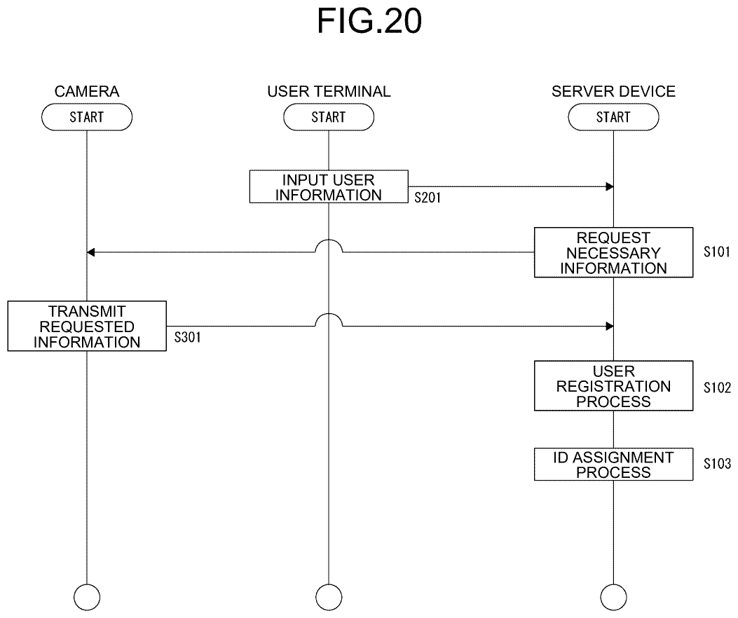

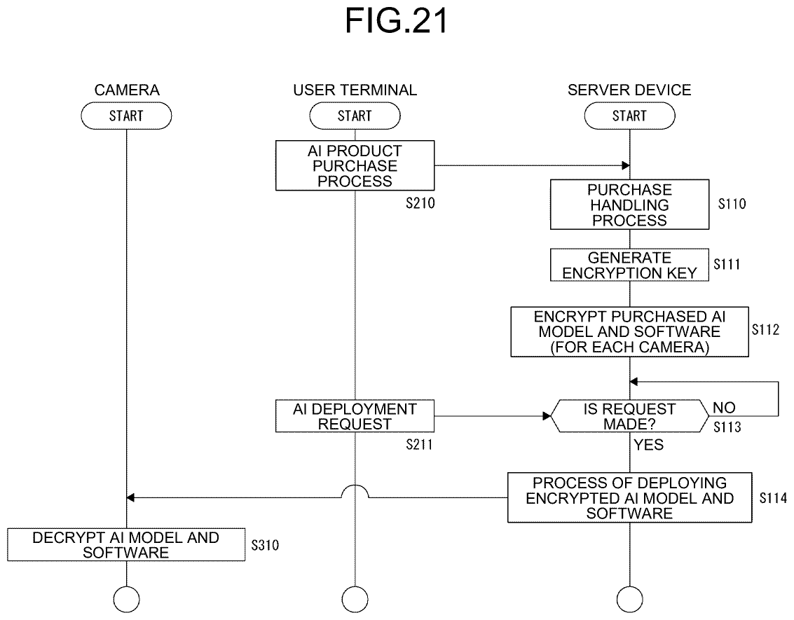

Here, for confirmation, a flow of processing of the entire information processing system 1C corresponding to a case where the processing in the use preparation processing unit 11a and the use start time processing unit 11b described above is performed is illustrated as flowcharts in FIGS. 20 and 21.

FIG. 20 is a flowchart of processing corresponding to registration of an account of a user, and FIG. 21 is a flowchart of processing corresponding to from purchase to deployment of AI-using software and an AI model.

In FIGS. 20 and 21, processing indicated as “server device” is processing executed by the CPU 11 of the server device 1, and processing indicated as “camera” is processing executed by the sensor internal control unit 43 in the camera 3. Note that processing indicated as “user terminal” is executed by a CPU of the user terminal 2.

Note that it is assumed that the user terminal 2 and the camera 3 are communicably connected to the server device 1 via the network 5 before the processing illustrated in FIGS. 20 and 21 is started.

In FIG. 20, the user terminal 2 performs a user information input process in step S201. That is, the process of inputting information for account registration (at least account on a user ID and a password) to the server device 1 based on an operation input of the user is performed.

The server device 1 receives the information input from the user terminal 2, and transmits necessary information for the account registration to the camera 3 in step S101. Specifically, a request is made for transmission of the above-described sensor ID, camera ID, region information, hardware type information, memory free space information (free space of the memory unit 45), information on the OS version, and the like which need to be associated with the user ID.

The camera 3 performs a process of transmitting information requested by the server device 1 to the server device 1 as the requested information transmission process in step S301.

The server device 1 that has received the requested information from the camera 3 performs generation of account information based on the user information input from the user terminal 2 and a process of associating the requested information received from the camera 3 with the user ID as a user registration process in step S102.

Then, in step S103 subsequent to step S102, the server device 1 performs an ID assignment process. That is, the process of assigning an ID to the camera 3 of the user whose account has been registered, specifically, issuance of a corresponding device ID for each connected camera 3 using the license authorization function F1 described above and association with the camera ID described above are performed, for example.

Next, the processing illustrated in FIG. 21 will be described.

First, the user terminal 2 executes an AI product purchase process in step S210. That is, the process for purchasing the AI-using software and the AI model in the above-described marketplace is executed. Specifically, as the process of step S210, the user terminal 2 instructs the server device 1 the AI-using software and the AI model to be purchased based on the operation input of the user, makes an instruction for purchase, and the like.

As a purchase handling process in step S110, the server device 1 performs a process for associating products (the AI-using software and the AI model) instructed to purchase by the user terminal 2 with the user as a purchaser. Specifically, the process of associating IDs (software ID and AI model ID) of the AI-using software and the AI model which have been instructed to purchase with the user ID of the user as the purchaser is performed.

In step S111 subsequent to step S110, the server device 1 generates an encryption key. That is, a key is generated by multiplying the sensor ID acquired from the camera 3 side in the processing of FIG. 20 described above, a master key of the camera 3 (image sensor 30), the user ID of the user as the purchaser, and the software ID and the AI model ID of the purchased AI-using software and AI model.

In step S112 subsequent to step S111, the server device 1 encrypts the purchased AI model and software. Specifically, the purchased AI model and AI-using software are encrypted using the key generated in step S111.

As described above, since the master key is used to generate the encryption key in this example, in a case where there are a plurality of target cameras 3, the key is generated for each of the cameras 3 (for each of the image sensors 30), and pieces of encrypted data are generated for the cameras 3, respectively, the pieces of encrypted data being encrypted with the keys different from each other.

After the process related to the purchase of the AI product as described above is performed, the user makes a deployment request to the server device 1 using the user terminal 2 when desiring to start image processing using the purchased AI-using software and AI model in each of the cameras 3 (“AI deployment request” in step S211).

After the above-described process of step S112 is executed, the server device 1 waits for the deployment request in step S113.

When the deployment request is made, the server device 1 performs a process of deploying the encrypted AI model and AI-using software in step S114. That is, the process of transmitting the encrypted data obtained in step S112 to the corresponding camera 3 (image sensor 30) is performed.

The camera 3 that has received the encrypted data transmitted from the server device 1 performs a process of decrypting the AI model and the AI-using software in step S310. That is, a key obtained by multiplying the master key stored in the nonvolatile memory unit 43m, the sensor ID, the user ID, the AI model ID, and the software ID is generated, and decryption processing is performed on the encrypted data using the generated key, thereby decrypting the AI-using software and the AI model.

The description returns to FIG. 19. In FIG. 19, the use control unit 11c monitors a use state of the camera 3 in which the AI-using software and the AI model have been deployed, and performs disabling processing of disabling at least use of the AI model based on a monitoring result. Specifically, the use control unit 11c determines whether the use state of the camera 3 corresponds to a specific use state, and performs the disabling processing of disabling the use of the AI model in the camera 3 in a case where it is determined that the use state corresponds to the specific use state.

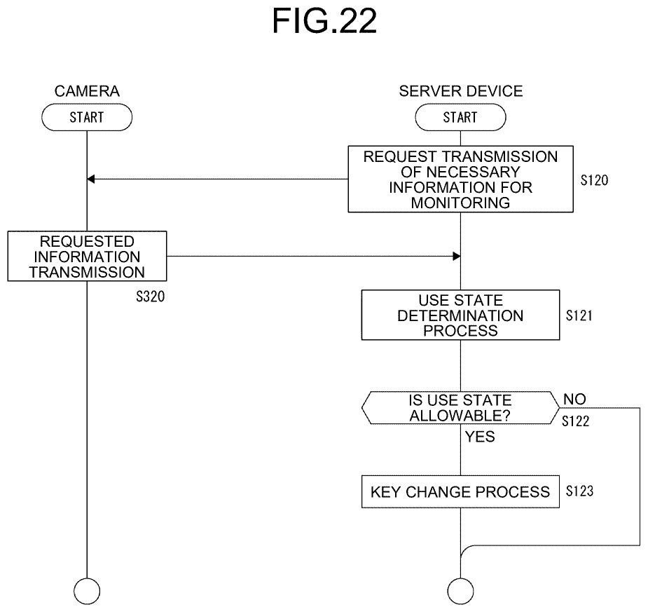

A specific processing example of the use control unit 11c will be described with reference to a flowchart of FIG. 22.

In FIG. 22, processing indicated as “server device” is executed by the CPU 11 of the server device 1, and processing indicated as “camera” is executed by, for example, the sensor internal control unit 43 in the camera 3.

First, in step S120, the server device 1 requests the camera 3 to transmit necessary information for monitoring. That is, the transmission request is made for the necessary information required for monitoring the use state of the camera 3.

Examples of the necessary information for monitoring here include output data of image processing using the AI model, output information (for example, information on a position, an altitude, a temperature, motion, and the like) of various sensors included in the sensor unit 36 of the camera 3, and free space information of the memory unit 45 (that is, a memory used in AI image processing).

Here, based on the output data of the AI image processing, data content, a data type, a data size, a data output frequency, and the like thereof can be grasped. In addition, based on outputs of the various sensors included in the camera 3, it is possible to grasp an environment, a situation, and the like in which the camera 3 is placed. In addition, based on the free space information of the memory unit 45, it is possible to estimate what kind of processing is being performed as the image processing using the AI model.

In response to the transmission request from the server device 1 in step S120, the camera 3 performs a process of transmitting the above-described necessary information to the server device 1 as a requested information transmission process in step S320.

In response to the reception of the necessary information from the camera 3, the server device 1 performs a process for determining the use state of the camera 3 using at least one of various types of information exemplified above as a use state determination process in step S121.

For example, in a case where information related to a location is used, it is determined whether a distance of a use location of the camera 3 from a predetermined expected use location (for example, a planned use location or the like of the camera 3 reported in advance by the user) is a certain distance or more. If the distance is equal to or more than the certain distance, the use state of the camera 3 in that case can be determined to be an unallowable use state.

In addition, in a case where information related to an altitude is used, it is conceivable to determine whether the altitude has a difference of a certain value or more from an altitude (expected use altitude) corresponding to the expected use location (for example, the planned use location or the like of the camera 3 reported in advance by the user) of the camera 3. When the altitude has a difference of the certain value or more from the expected use altitude, it can be estimated that the camera 3 is not used in the expected location (for example, a case where the camera 3, which is to be used for indoor installation, is mounted on a flying object such as a drone, or the like). That is, it can be determined that the use state is unallowable.

Furthermore, in a case where information related to a temperature is used, it is conceivable to determine whether the temperature has a difference of a certain value or more from a temperature (expected use temperature) corresponding to the expected use location of the camera 3. When there is a difference of the certain value or more from the expected use temperature, it is estimated that a use location is different from the expected use location, and thus it can be determined that the use state is unallowable.

In addition, in a case where information related to motion of the camera 3 is used, it is conceivable to determine whether the motion is different from predetermined motion expected from an expected use environment (for example, indoor installation, installation on a moving object, or the like) of the camera 3. For example, when motion of the camera 3 is detected despite the indoor installation, it can be determined that the use state is an unexpected use state and is unallowable.

In addition, in a case where output data of the AI image processing is used, it is conceivable to determine whether an output frequency of the output data has a difference of a certain value or more from an output frequency (expected output frequency) expected from a predetermined use purpose of the camera 3. When the output frequency of the output data of the AI image processing has a difference of the certain value or more from the expected output frequency, it can be estimated that a use purpose of the camera 3 is different from the expected use purpose, and it can be determined that the use state is unallowable.

In addition, in a case where output data of the AI image processing is used, the use state of the camera 3 can be estimated based on data content thereof. For example, when the output data is image data, it is possible to determine whether a use location, a use environment, and a use purpose of the camera 3 match those expected based on image content, and it is possible to determine whether the use state of the camera 3 is an allowable use state.

Furthermore, in a case where free space information of the memory unit 45 is used, it is conceivable to determine whether a free space has a difference of a certain value or more from a free space (expected free space) expected from the predetermined use purpose of the camera 3. When the free space of the memory unit 45 has a difference of the certain value or more from the expected free space, for example, it can be estimated that a use purpose of the camera 3 is different from the expected use purpose, and it can be determined that the use state is unallowable.

In step S122 subsequent to step S121, the server device 1 determines whether the use state is allowable. That is, it is determined whether the use state of the camera 3 is an allowable use state based on a result of the use state determination process in step S121.

Note that the above description has been made with the example in which, regarding the determination of the use state of the camera 3, a use determination is made from only one piece of information, but a comprehensive use determination can also be made based on a plurality of pieces of information. For example, it is conceivable to make use state determinations using information related to a location and information related to an altitude, to obtain a determination result that the use state is allowable in a case where it is determined to be the allowable use state in both the use state determinations, and to obtain a determination result that the use state is unallowable in a case where it is determined to be the unallowable use state in either one of the both. Alternatively, it is also conceivable to further make a use state determination based on information on motion, to obtain a determination result that the use state is allowable in a case where it is determined to be the allowable use state in all the use state determinations, and to obtain a determination result that the use state is unallowable in a case where it is determined to be the unallowable use state in any one thereof.

In a case where it is determined in step S122 that the use state of the camera 3 is not the allowable use state, the server device 1 proceeds to step S123 and performs a key change process. That is, the process of changing a key used for encryption of the AI-using software and the AI model is performed.

Specifically, as the key change process, the server device 1 changes at least any key excluding the master key among respective keys of the master key, the sensor ID, the user ID, the software ID, and the AI model ID, which are used for key generation, to another key, and generates a new key by multiplying the respective keys including the changed key.

Here, among the above-described respective keys of the master key, the sensor ID, the user ID, the software ID, and the AI model ID, the keys other than the master key correspond to “designated keys” designated to be used for generating key information for decryption of the encrypted AI-using software and AI model.

Since the memory unit 45 in which the AI model is stored is the volatile memory in the present embodiment, and it is necessary to redeploy the AI-using software and the AI model from the server device 1 when the camera 3 is reactivated. Therefore, when the key used for encryption of the AI model and the AI-using software is changed as described above, decryption of the AI-using software and the AI model is disabled in the camera 3 (image sensor 30). That is, the camera 3 cannot perform the image processing using the AI model.

Note that, after the encryption key is changed as described above, the server device 1 transmits the AI-using software and the AI model encrypted with the changed key to the camera 3 in response to a deployment request from the camera 3 although not illustrated.

Here, the above description has been made with the example in which the use state determination is made using information acquired from the camera 3 as the determination of the use state of the camera 3, but the use state determination can also be made based on information other than the information acquired from the camera 3.

For example, the use state determination can also be made based on information on an Internet protocol (IP) address assigned to the camera 3 in communication via the network 5. In this case, for example, it is conceivable to determine whether a location of the camera 3 specified from the IP address is different from a predetermined location.

Alternatively, the use state determination can also be made based on payment information of a purchase cost for the AI-using software and the AI model. This makes it possible to disable the use of the AI model in the camera 3 in response to, for example, a case where the user has not paid a specified purchase cost.

Note that it can be said that a state where the user uses the camera 3 without paying the specified purchase cost is a use state without payment and is an improper use state.

In addition, it is also conceivable to make the use state determination based on information indicating which AI model is being used by the camera 3. For example, in a case where an AI model that is not in a deployment history is being used, it can be determined that the use state of the camera 3 is an unauthorized use state, and in that case, it is conceivable to disable the use of the AI model.

### 2-3. Output Data Security Processing as Embodiment

Next, output data security processing performed on the camera 3 side will be described.

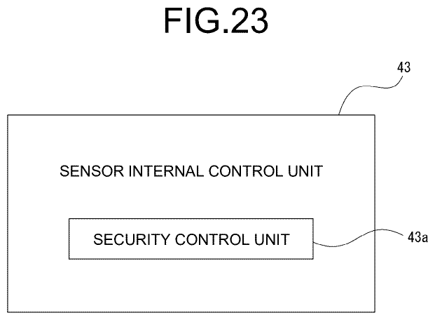

FIG. 23 is a functional block diagram for describing functions related to security control of the sensor internal control unit 43 in the camera 3.

As illustrated in FIG. 23, the sensor internal control unit 43 includes a security control unit 43a.

The security control unit 43a performs control to switch a level of security processing with respect to output data based on the output data of image processing performed using an AI model.

The term “security processing” referred to herein means processing for enhancing safety from the viewpoint of data content leakage prevention and spoofing prevention, such as encryption processing on target data or processing of adding electronic signature data for authenticity determination to target data. The term “to switch a level of security processing” means to switch a level of safety from the viewpoint of such data content leakage prevention and spoofing prevention.

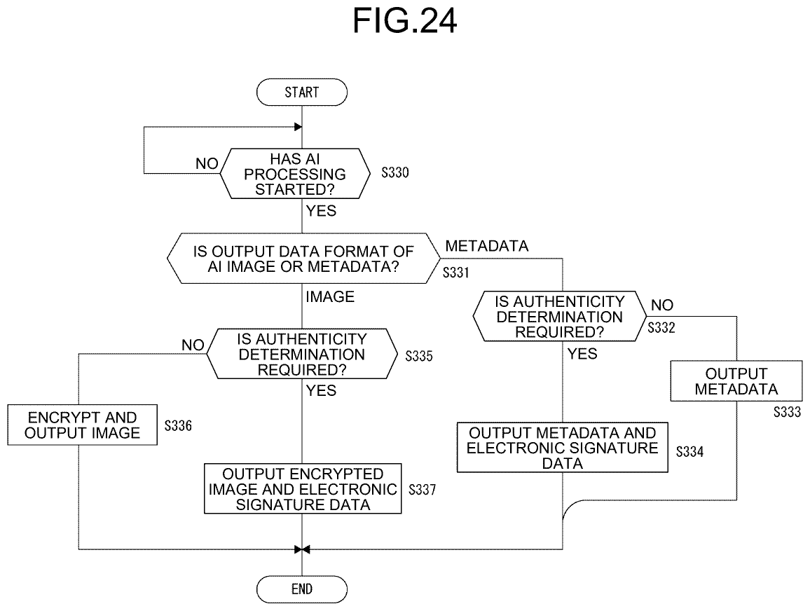

FIG. 24 is a flowchart illustrating an example of specific processing performed by the security control unit 43a.

In FIG. 24, the sensor internal control unit 43 waits for the start of AI processing in step S330. That is, the sensor internal control unit 43 waits for the start of the image processing using the AI model performed by the AI image processing unit 44 illustrated in FIG. 18.

When the AI processing is started, the sensor internal control unit 43 determines whether an output data format of AI is an image or metadata in step S331. That is, it is determined whether the output data format of the image processing using the AI model is the image or the metadata.

Here, there are an AI model that outputs image data as result information of AI image processing and an AI model that outputs metadata (attribute data). The image data in this case is assumed to be, for example, image data of a recognized face, whole body, half body, or the like in a case where a subject is a person, image data of a recognized license plate in a case where the subject is a vehicle, or the like. In addition, the metadata is assumed to be text data or the like indicating attribute information such as age (or an age group) and gender of a subject as a target.

The image data is highly specific information such as an image of a target face, and thus can be said to be data that is likely to include personal information of the subject. On the other hand, the metadata tends to be abstract attribute information as exemplified above, and thus can be said to be data that hardly includes personal information.

In a case where it is determined in step S331 that the output data format of the AI is the metadata, the sensor internal control unit 43 proceeds to step S332 and determines whether authenticity determination is required.

Here, it is also assumed that the output data of image processing performed using the AI model in the camera 3 is used, for example, for face authentication processing of a person as a target. In that case, it is assumed that the output data is transmitted to an external device outside the image sensor 30, such as the server device 1, and the external device performs the face authentication processing. In that case, it is conceivable that a device spoofing the authorized image sensor 30 fraudulently pass face authentication by transmitting false data for the face authentication to the external device.

Therefore, in the information processing system 1C of this example, a private key for generating electronic signature data is stored in the camera 3 so as to enable authenticity determination for the output data of the image processing using the AI model in the camera 3.

In step S332, whether the authenticity determination of the output data is required is performed as, for example, determination as to whether the output data is used for predetermined authentication processing such as the face authentication processing as exemplified above. Specifically, based on content of the output data, it is determined whether the output data is data used for the authentication processing such as the face authentication processing. This processing can be performed, for example, as determination as to whether a combination of attribute items included in the metadata is a predetermined combination.

In a case where it is determined that the authenticity determination is not required, the sensor internal control unit 43 proceeds to step S333, performs a process of outputting the metadata, and ends the series of processing illustrated in FIG. 24.

That is, since the output data is not the image data but the metadata (which hardly includes personal information) and it is determined that the authenticity determination is not required for the metadata in this case, the process of directly outputting the metadata as the output data of the AI image processing (outputting at least to the outside of the image sensor 30) is performed.

On the other hand, in a case where it is determined in step S332 that the authenticity determination of the output data is required, the sensor internal control unit 43 proceeds to step S334, performs a process of outputting the metadata and the electronic signature data, and ends the series of processing illustrated in FIG. 24. That is, the process of generating the electronic signature data based on the metadata, which is the output data, and the above-described private key and outputting the metadata and the electronic signature data is performed.

As a result, in a case where the output data is not the image data but the metadata and it is determined that the authenticity determination is required for the metadata, the electronic signature data for the authenticity determination is output together with the metadata.

In addition, in a case where it is determined in the above step S331 that the output data format of the AI is the image, the sensor internal control unit 43 proceeds to step S335 and determines whether authenticity determination is required. The determination as to whether the authenticity determination for the image data is required can be performed, for example, based on content of the image data. Specifically, based on the content of the image data, which is the output data, it is determined whether the output data is data used for the authentication processing such as the face authentication processing. This processing can be performed, for example, as determination as to whether a subject (for example, a face, an iris, or the like) used for the authentication processing is included in the image data.

In a case where it is determined that the authenticity determination is not required, the sensor internal control unit 43 proceeds to step S336, performs a process of encrypting and outputting the image, and ends the series of processing illustrated in FIG. 24.

That is, in this case, the output data is encrypted, but the electronic signature data for the authenticity determination is not output.

In addition, in a case where it is determined in step S335 that the authenticity determination is required, the sensor internal control unit 43 proceeds to step S337, performs a process of outputting the encrypted image and the electronic signature data, and ends the series of processing illustrated in FIG. 24.

As a result, the output data is encrypted in response to the case where the output data includes the image data that is likely to include personal information, and the electronic signature data is output together with the output data in response to the case where authenticity determination is required.

Note that the above description has been made with the example in which the determination as to whether to perform encryption is performed as the determination as to whether the output data is the image, but the determination can also be performed based on the content of the output data. For example, in a case where the output data is the image data, it is possible to determine whether encryption is required based on content of the image (for example, whether personal information is likely to be included). Specifically, it is determined that the encryption is required if a face of a person is included in the image, and it is determined that the encryption is not required if the face is not included.

In addition, two-stage switching, that is, switching between execution and non-execution of encryption is performed as switching of an encryption level in the above description, but the switching of the encryption level can be performed as switching in three or more stages.

For example, in a case where the encryption level is switched in three or more stages, a required encryption level is determined according to the number of subjects required to be protected included in the output data as the image data. As a specific example, for example, it is conceivable to partially encrypt only a face portion in a case where the number of faces of persons included in the image is only one, to partially encrypt two face portions in a case where the number is two, and to partially encrypt three face portions in a case where the number is three. In this case, the amount of data to be encrypted is switched in three or more stages.

In addition, it is also possible to determine whether encryption is required or determine which level is requested as the encryption level based on a size of a subject in the image. That is, it is determined to perform the encryption in a case where the size of the subject in the image is equal to or larger than a predetermined size, or the encryption level is increased as the size of the subject in the image increases.

### 2-4. Modifications

Note that embodiments are not limited to the above-described specific example, and configurations as various modifications can be adopted.

### 2-4-1. Connection Between Cloud and Edge

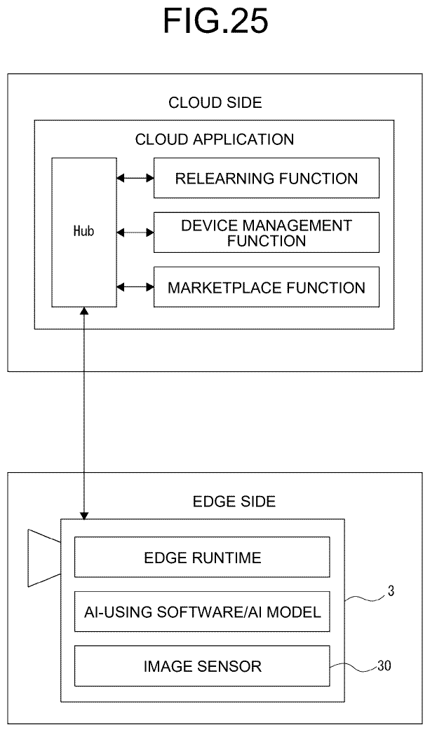

For example, a mode as illustrated in FIG. 25 can be considered regarding a connection between the server device 1, which is an information processing device on a cloud side, and the camera 3 which is an information processing device on an edge side.

The information processing device on the cloud side is equipped with a relearning function, a device management function, and a marketplace function which are functions available via Hub. The Hub performs highly reliable communication protected by security with respect to the information processing device on the edge side. This makes it possible to provide various functions to the information processing device on the edge side.

The relearning function is a function of performing relearning and providing a newly optimized AI model as described above, whereby an appropriate AI model based on a new learning material is provided.

The device management function is a function of managing the camera 3 as the information processing device on the edge side and the like, and can provide, for example, functions such as management and monitoring of an AI model deployed in the camera 3, detection of trouble, and troubleshooting. In addition, the device management function protects secure access by an authenticated user.

As described above, the marketplace function provides a function of registering an AI model developed by an AI model developer and AI-using software developed by a software developer, a function of deploying these developments to a permitted edge-side information processing device, and the like. In addition, the marketplace function also provides a function related to payment of an incentive according to deployment of a development.

The camera 3 as the information processing device on the edge side includes edge runtime, AI-using software, an AI model, and the image sensor 30.

The edge runtime functions as, for example, embedded software for performing management of software deployed in the camera 3 and communication with the information processing device on the cloud side.

As described above, the AI model is obtained by deployment of the AI model registered in the marketplace in the information processing device on the cloud side, and thus the camera 3 can obtain result information of AI image processing according to a purpose using a captured image.

### 2-4-2. Sensor Structure

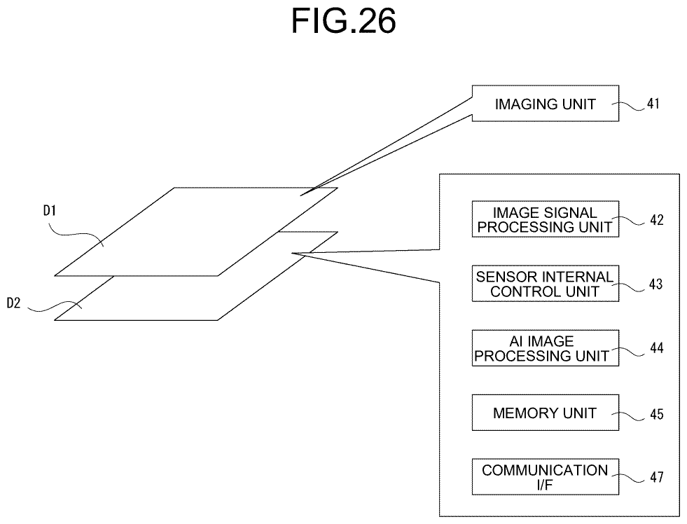

Although various structures of the image sensor 30 can be considered, a two-layer structure as illustrated in FIG. 26 will be described here as an example.

In FIG. 26, the image sensor 30 in this case is configured as a one-chip semiconductor device in which two dies, that is, dies D1 and D2 are stacked. The die D1 is a die on which the imaging unit 41 (see FIG. 18) is formed, and the die D2 is a die including the image signal processing unit 42, the sensor internal control unit 43, the AI image processing unit 44, the memory unit 45, the computer vision processing unit 46, and the communication I/F 47. The die D1 and the die D2 are electrically connected by, for example, a chip-to-chip bonding technique such as Cu—Cu bonding.

### 2-4-3. Deployment Using Container Technology

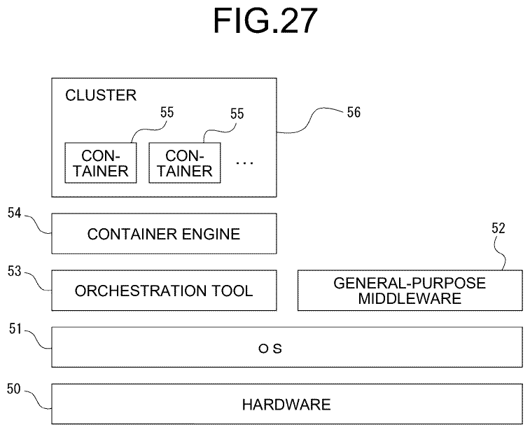

In addition, various methods of deploying an AI model and AI-using software to the camera 3 can be considered. As an example, an example using a container technology will be described with reference to FIG. 27.

As illustrated in FIG. 27, in the camera 3, an operation system 51 is installed on various types of hardware 50 such as a CPU, a graphics processing unit (GPU), a ROM, and a RAM as the control unit 33 illustrated in FIG. 18 described above.

The operation system 51 is basic software that performs overall control of the camera 3 in order to realize various functions in the camera 3.

General-purpose middleware 52 is installed on the operation system 51. The general-purpose middleware 52 is, for example, software for realizing basic operations such as a communication function using the communication unit 35 as the hardware 50 and a display function using a display unit (such as a monitor) as the hardware 50.

Not only the general-purpose middleware 52 but also an orchestration tool 53 and a container engine 54 are installed on the operation system 51.

The orchestration tool 53 and the container engine 54 deploy and execute containers 55 by constructing a cluster 56 as an operation environment of the containers 55.

Note that the edge runtime illustrated in FIG. 25 corresponds to the orchestration tool 53 and the container engine 54 illustrated in FIG. 27.

The orchestration tool 53 has a function for causing the container engine 54 to appropriately allocate resources of the hardware 50 and the operation system 51 described above. Each of the containers 55 is collected in a predetermined unit (pod to be described below) by the orchestration tool 53, and each pod is deployed to a worker node (to be described below) which is a logically different area.

The container engine 54 is one type of middleware installed in the operation system 51, and is an engine that operates the containers 55. Specifically, the container engine 54 has a function of allocating the resources (a memory, operation capability, and the like) of the hardware 50 and the operation system 51 to the containers 55 based on a configuration file and the like included in middleware in the containers 55.

In addition, the resources allocated in the present embodiment include not only resources of the control unit 33 and the like included in the camera 3 but also resources of the sensor internal control unit 43, the memory unit 45, the communication I/F 47, and the like included in the image sensor 30.

The container 55 includes an application for realizing a predetermined function and middleware such as a library. The container 55 operates to realize the predetermined function using the resources of the hardware 50 and the operation system 51 allocated by the container engine 54.

In the present embodiment, the AI-using software and the AI model illustrated in FIG. 25 correspond to one of the containers 55. That is, one of the various containers 55 deployed in the camera 3 realizes a predetermined AI image processing function using the AI-using software and the AI model.

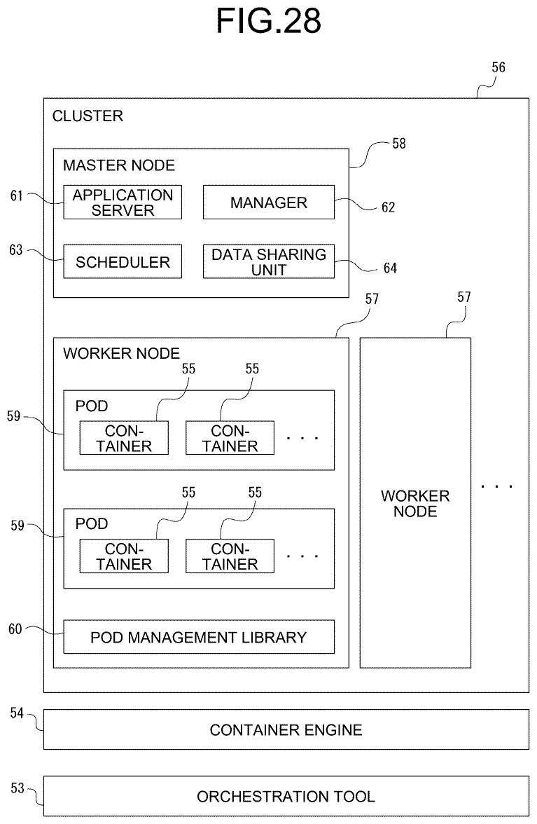

A specific configuration example of the cluster 56 constructed by the container engine 54 and the orchestration tool 53 will be described with reference to FIG. 28.

Note that the cluster 56 may be constructed across a plurality of apparatuses so as to realize a function using not only the hardware 50 included in the single camera 3 but also other hardware resources included in other devices.

The orchestration tool 53 manages execution environments of the containers 55 in units of worker nodes 57. In addition, the orchestration tool 53 constructs a master node 58 that manages all the worker nodes 57.

In the worker node 57, a plurality of pods 59 are deployed. The pod 59 includes one or a plurality of the containers 55, and realizes a predetermined function. The pod 59 is a unit of management for managing the containers 55 by the orchestration tool 53.

An operation of the pod 59 in the worker node 57 is controlled by a pod management library 60.

The pod management library 60 includes a container runtime for causing the pod 59 to use logically allocated resources of the hardware 50, an agent under control of the master node 58, a network proxy that performs communication between the pods 59 and communication with the master node 58, and the like.

That is, the pod management library 60 enables each of the pods 59 to realize a predetermined function using each resource.

The master node 58 includes an application server 61 that deploys the pod 59, a manager 62 that manages a deployment situation of the container 55 by the application server 61, a scheduler 63 that determines the worker node 57 in which the container 55 is to be arranged, and a data sharing unit 64 that performs data sharing.

When the configurations illustrated in FIGS. 27 and 28 are used, the above-described AI-using software and AI model can be deployed in the image sensor 30 of the camera 3 using the container technology.

Note that, as described above, the AI model may be stored in the memory unit 45 in the image sensor 30 via the communication I/F 47 in FIG. 18, and the AI image processing may be executed in the image sensor 30. Alternatively, the configurations illustrated in FIGS. 27 and 28 may be deployed in the memory unit 45 and the sensor internal control unit 43 in the image sensor 30 to execute the above-described AI-using software and AI model in the image sensor 30 using the container technology.

### 2-4-4. Flow of Processing Related to AI Model Relearning

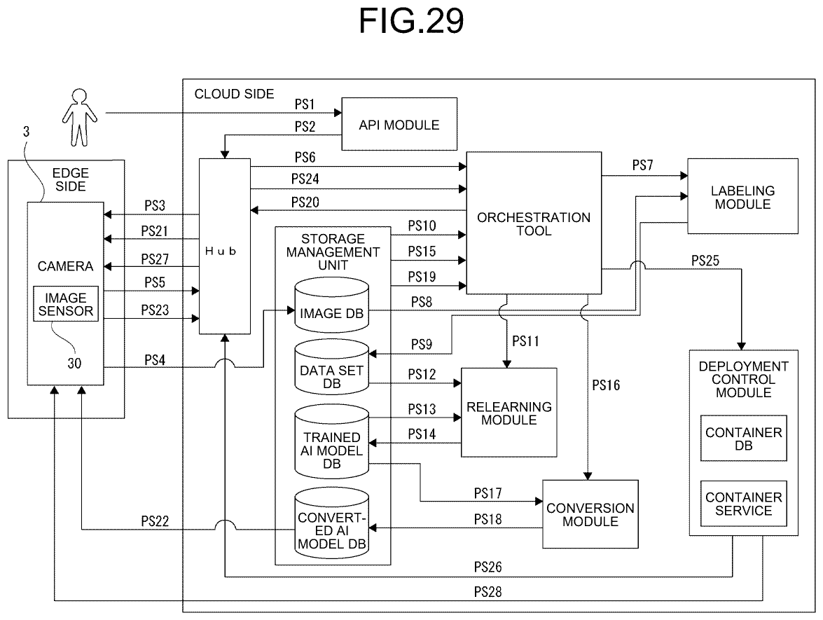

An example of a flow of processing when AI model relearning and update of an AI model (edge-side AI model) and AI-using software, which have been deployed in each of the cameras 3, are performed will be described with reference to FIG. 29.

Here, as an example, a case where the AI model relearning and the update of the edge-side AI model and the AI-using software are performed with an operation of a service provider or a user (user) as a trigger will be described.

Note that FIG. 29 focuses on one camera 3 among the plurality of cameras 3. In addition, the edge-side AI model to be updated in the following description has been deployed in the image sensor 30 included in the camera 3. However, the edge-side AI model may be deployed in a memory provided in a portion outside the image sensor 30 and inside the camera 3.

First, in processing step PS1, the service provider or the user makes an instruction for the AI model relearning. This instruction is made using an application programming interface (API) function by an API module included in an information processing device on a cloud side. In addition, in the instruction, an image amount (for example, the number of images) used for learning is designated. Hereinafter, the number of images designated as the image amount used for learning is also referred to as a “predetermined number”.

In response to the instruction, the API module transmits a relearning request and image amount information to Hub (similar to one illustrated in FIG. 25) in processing step PS2.

In processing step PS3, the Hub transmits an update notification and the image amount information to the camera 3 which is an information processing device on an edge side.

The camera 3 transmits captured image data obtained by performing image capturing to an image database (DB) of a storage group in processing step PS4. Such image capturing processing and transmission processing are performed until the predetermined number required for relearning is achieved.

Note that, when an inference result is obtained by performing inference processing on the captured image data, the camera 3 may store the inference result in the image DB as metadata of the captured image data in processing step PS4.

Since the inference result in the camera 3 is stored in the image DB as the metadata, it is possible to carefully select data necessary for the AI model relearning executed on the cloud side. Specifically, the relearning can be performed using only image data for which the inference result in the camera 3 is different from a result of inference executed using abundant computer resources by the information processing device on the cloud side. Therefore, the time required for relearning can be shortened.

After the image capturing and transmission corresponding to the predetermined number are finished, the camera 3 notifies the Hub that the transmission of the predetermined number of pieces of captured image data has been completed in processing step PS5.

The Hub receiving the notification notifies an orchestration tool that preparation of data for relearning is completed in processing step PS6.

In processing step PS7, the orchestration tool transmits an instruction for executing a labeling process to a labeling module.

The labeling module acquires image data to be subjected to the labeling process from the image DB (in processing step PS8), and performs the labeling process.

The term “labeling process” referred to herein may be a process of performing the above-described class identification, a process of estimating gender and age of a subject of an image and assigning a label, a process of estimating a pose of the subject and assigning a label, or a process of estimating a behavior of the subject and assigning a label.

The labeling process may be performed manually or automatically. In addition, the labeling process may be completed by the information processing device on the cloud side, or may be realized using a service provided by another server device.

The labeling module having finished the labeling process stores labeling result information in a data set DB in processing step PS9. Here, the information to be stored in the data set DB may be a set of label information and image data, or may be image identification (ID) information for identifying image data instead of the image data itself.

A storage management unit having detected that the labeling result information is stored issues a notification to the orchestration tool in processing step PS10.

The orchestration tool having received the notification confirms that the labeling process for the predetermined number of pieces of image data has ended, and transmits a relearning instruction to the relearning module in processing step PS11.

The relearning module having received the relearning instruction acquires a data set to be used for learning from the data set DB in processing step PS12, and acquires an AI model to be updated from a trained AI model DB in processing step PS13.

The relearning module performs the AI model relearning using the acquired data set and AI model. The updated AI model obtained in this manner is stored again in the trained AI model DB in processing step PS14.

The storage management unit having detected that the updated AI model is stored issues a notification to the orchestration tool in processing step PS15.

The orchestration tool having received the notification transmits a conversion instruction for the AI model to a conversion module in processing step PS16.

The conversion module having received the conversion instruction acquires the updated AI model from the trained AI model DB in processing step PS17, and performs conversion processing of the AI model.

In the conversion processing, processing of performing conversion in accordance with specification information or the like of the camera 3, which is a deployment destination apparatus, is performed. In this processing, downsizing is performed so as not to degrade the performance of the AI model as much as possible, and file format conversion or the like is performed so as to be operable on the camera 3.

The AI model converted by the conversion module is the above-described edge-side AI model. The converted AI model is stored in a converted AI model DB in processing step PS18.

The storage management unit having detected that the converted AI model is stored issues a notification to the orchestration tool in processing step PS19.

In processing step PS20, the orchestration tool having received the notification transmits a notification for executing update of the AI model to the Hub. This notification includes information for specifying a location where the AI model to be used for the update is stored.

The Hub having received the notification transmits an update instruction for the AI model to the camera 3. The update instruction also includes the information for specifying the location where the AI model is stored.

In processing step PS22, the camera 3 performs a process of acquiring and deploying the target converted AI model from the converted AI model DB. As a result, the AI model used by the image sensor 30 of the camera 3 is updated.

The camera 3 having completed the update of the AI model by deploying the AI model transmits an update completion notification to the Hub in processing step PS23.

The Hub having received the notification notifies the orchestration tool that AI model update processing of the camera 3 has been completed in processing step PS24.

Note that, in a case where only the update of the AI model is performed, the processing so far is completed.

In a case where update of AI-using software that uses the AI model as well as the AI model is performed, the following processing is further executed.

Specifically, in processing step PS25, the orchestration tool transmits an instruction for downloading the AI-using software such as updated firmware to a deployment control module.

In processing step PS26, the deployment control module transmits a deployment instruction for the AI-using software to the Hub. This instruction includes information for specifying a location where the updated AI-using software is stored.

In processing step PS27, the Hub transmits the deployment instruction to the camera 3.

In processing step PS28, the camera 3 downloads and deploy the updated AI-using software from a container DB of the deployment control module.

Note that the example in which the update of the AI model operating on the image sensor 30 of the camera 3 and the update of the AI-using software operating outside the image sensor 30 in the camera 3 are sequentially performed has been described in the above description.

In a case where both the AI model and the AI-using software operate outside the image sensor 30 of the camera 3, both the AI model and the AI-using software may be collectively updated as one container. In that case, the update of the AI model and the update of the AI-using software may be performed not sequentially but simultaneously. This can be realized by executing the respective processes of processing steps PS25, PS26, PS27, and PS28.

Note that, also in a case where a container can be deployed in the image sensor 30 of the camera 3, the AI model and the AI-using software can be updated by executing the respective processes of processing steps PS25, PS26, PS27, and PS28.

By performing the above-described processing, the AI model relearning is performed using the captured image data captured in a use environment of the user. Therefore, it is possible to generate the edge-side AI model capable of outputting a highly accurate recognition result in the use environment of the user.

In addition, even if the use environment of the user changes, for example, when a layout in a store is changed or an installation location of the camera 3 is changed, the AI model relearning can be appropriately performed every time, and thus the recognition accuracy by the AI model can be maintained without degradation.

Note that the respective processes described above may be executed not only when the AI model relearning is performed but also when a system is run for the first time under the use environment of the user.

### 2-4-5. Screen Example of Marketplace

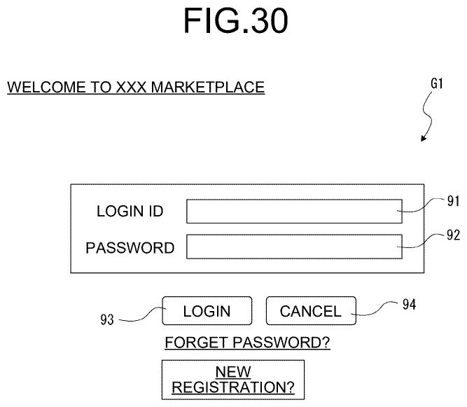

A screen example of the marketplace presented to a user will be described with reference to FIGS. 30 to 32.

FIG. 30 illustrates an example of a login screen G1.

The login screen G1 is provided with an ID input field 91 for inputting a user ID and a password input field 92 for inputting a password.

Below the password input field 92, a login button 93 for performing login and a cancel button 94 for canceling login are arranged.

In addition, below the login button 93 and the cancel button 94, an operation element for transitioning to a page designed for a user who has forgotten a password, an operation element for transitioning to a page for newly performing user registration, and the like are appropriately arranged.

When the login button 93 is pressed after appropriate user ID and password are input, a process of transitioning to a user-specific page is executed in each of the server device 1 and the user terminal 2.

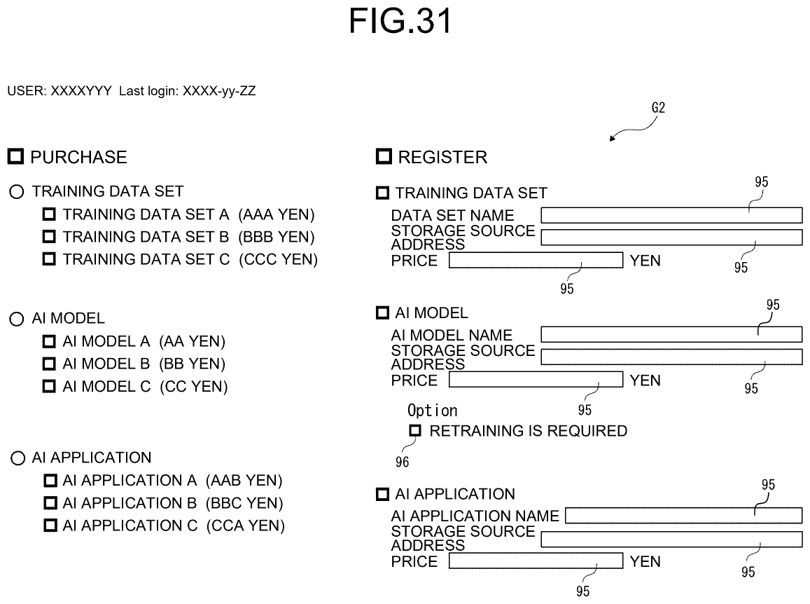

FIG. 31 illustrates an example of a developer-oriented screen G2 presented to a software developer who uses the software developer terminal 7 and an AI model developer who uses the AI model developer terminal 6.

Each of the developers can purchase training data sets, AI models, and AI-using software (denoted as “AI applications” in the drawing) for development through the marketplace. In addition, each of the developers can register AI-using software and an AI model developed by himself/herself in the marketplace.

On the developer-oriented screen G2 illustrated in FIG. 31, the purchasable training data sets, AI models, AI-using software (AI applications), and the like (hereinafter, collectively referred to as “data”) are displayed on the left side.

Note that, although not illustrated, an image of a training data set can be displayed on a display when the training data set is purchased, and preparation for learning can be performed just by surrounding only a desired portion of the image with a frame using an input device such as a mouse and inputting a name.

For example, in a case where it is desired to perform AI learning with an image of a cat, an image to which an annotation of the cat has been added can be prepared for AI learning by surrounding only a portion of the cat on the image with a frame and inputting “cat” as a text input.

In addition, a purpose may be selectable such that desired data can be easily found. That is, display processing in which only data suitable for the selected purpose is displayed is executed in each of the server device 1 and the user terminal 2.

Note that a purchase price of each data may be displayed on the developer-oriented screen G2.

In addition, input fields 95 for registering training data sets collected or created by the developers and AI models and AI-using software developed by the developers are provided on the right side of the developer-oriented screen G2.

The input fields 95 for inputting a name and a data storage location are provided for each data. In addition, a check box 96 for setting whether retraining is required or not required is provided for the AI model.

Note that a price setting field in which a sales price of data to be registered can be set may be provided as the input field 95.

In addition, in the upper part of the developer-oriented screen G2, a user name, a final login date, and the like are displayed as part of user information. Note that, other than this, the amount of money, the number of points, or the like that can be used when a user purchases data may be displayed.

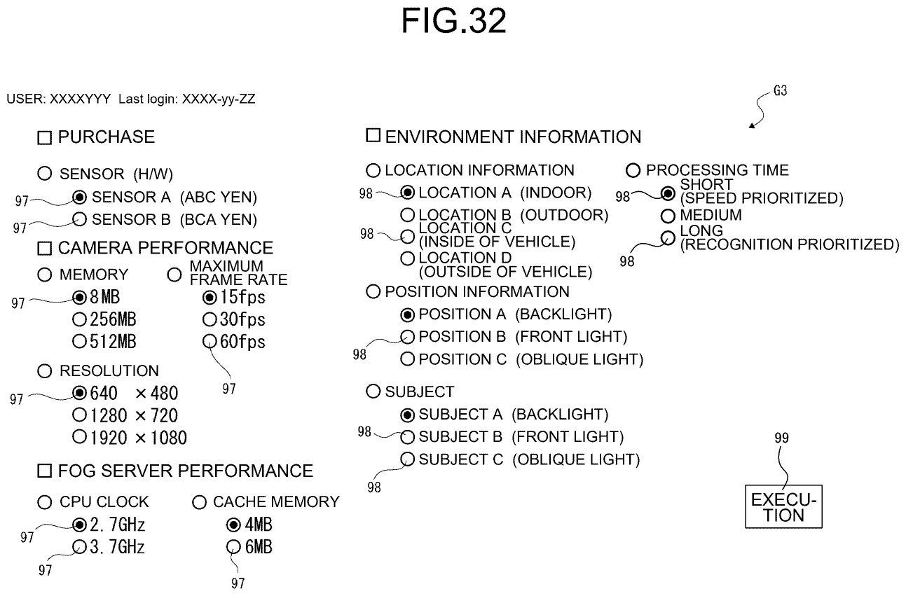

FIG. 32 is an example of a user-oriented screen G3. The user-oriented screen G3 is a screen presented to a user as a service user, that is, a user (user using the above-described application) who receives presentation of various analysis results by deploying AI-using software or an AI model in the camera 3 managed by himself/herself.

The user can purchase the camera 3 that is to be arranged in a space to be monitored through the marketplace. Therefore, on the left side of the user-oriented screen G3, radio buttons 97 which enable selection of a type of the image sensor 30 mounted on the camera 3, performance of the camera 3, and the like are arranged.

In addition, the user can purchase an information processing device as the FOG server 4 through the marketplace. Therefore, the radio buttons 97 for selecting each performance of the FOG server 4 are arranged on the left side of the user-oriented screen G3.

In addition, the user who already has the FOG server 4 can register the performance of the FOG server 4 by inputting performance information of the FOG server 4 here.

The user realizes a desired function by installing the purchased camera 3 (alternatively, the camera 3 purchased without going through the marketplace may be used) in any location such as a store managed by himself/herself, and information on the installation location of the camera 3 can be registered in the marketplace in order to maximize functions of each of the cameras 3.

On the right side of the user-oriented screen G3, radio buttons 98 which enable selection of environment information regarding an environment in which the camera 3 is installed are arranged. Examples of the environment information selectable as illustrated in the drawing include an installation location and a type of a position of the camera 3, a type of a subject to be captured, a processing time, and the like.

The user can set the above-described optimum imaging settings in the target camera 3 by appropriately selecting the environment information regarding the environment in which the camera 3 is installed.

Note that, in a case where an installation location of the camera 3 planned to be purchased has been determined with the purchase of the camera 3, the camera 3 in which the optimum imaging settings are set in advance can be purchased according to a planned installation location by selecting each item on the left side and each item on the right side of the user-oriented screen G3.

In addition, an execution button 99 is provided on the user-oriented screen G3. As the execution button 99 is pressed, the screen transitions to a confirmation screen for confirming purchase or a confirmation screen for confirming settings of the environment information. As a result, the user can purchase a desired camera 3 or a desired FOG server 4, and can set the environment information for the camera 3.

In the marketplace, it is possible to change the environment information of each of the cameras 3 in response to a change in the installation location of the camera 3. It is possible to re-set the optimum imaging settings for the camera 3 by re-inputting the environment information regarding the installation location of the camera 3 on a change screen (not illustrated).

### 2-4-6. Other Modifications

Here, the above description has been made with the example in which the use of the AI model is disabled by disabling the decryption of the AI model and the AI-using software as processing related to disabling of use of the AI model, but it is also possible to realize the disabling of use of the AI model in the camera 3 by similarly performing encryption and the key change at the time of unauthorized use with respect to firmware required for performing the AI image processing by the AI image processing unit 44.

In addition, the configuration in which the AI image processing is performed in the image sensor 30 has been exemplified in the above description, but a configuration in which the AI image processing is performed outside the image sensor 30 may be adopted. For example, the AI image processing may be performed by a processor provided in a portion outside the image sensor 30 and inside the camera 3, or may be performed by a processor provided in the FOG server 4.

In addition, the case where the camera 3 is configured to obtain the color image as the captured image has been exemplified in the above description, but the term “imaging” in the present specification broadly means obtaining image data in which a subject is captured. The term “image data” referred to here is a generic term for data including a plurality of pieces of pixel data, and the pixel data is a concept broadly including not only data indicating the intensity of the amount of light received from the subject but also, for example, distance to the subject, polarization information, temperature information, and the like. That is, the “image data” obtained by “imaging” includes data as a grayscale image indicating information on the intensity of the amount of received light for each pixel, data as a distance image indicating information on the distance to the subject for each pixel, data as a polarized image indicating the polarization information for each pixel, data as a thermal image indicating the temperature information for each pixel, and the like.

In addition, regarding the security control for output data of the AI image processing, when an encryption target area of the output data as an image is determined, it is also conceivable to provide a distance measuring sensor such as a time of flight (ToF) sensor in the camera 3 as an external sensor of the image sensor 30, and encrypt only a subject portion within a predetermined distance as a target.

In addition, the case where the information processing system 1C includes the AI cameras as the cameras 3 has been exemplified in the above description, but a camera that does not have an image processing function using an AI model can be used as the camera 3.

In that case, it is conceivable to set software or firmware deployed other than being used in AI as an encryption target, and it is possible to disable the use of the software or firmware according to a use situation thereof.

In addition, it is also conceivable to recognize (for example, determine a skin color or the like) whether a person appears in an output image from a sensor by rule-based processing instead of AI processing, and switch a security level of the output image according to a recognition result.

### 2-5. Summary of Embodiment

As described above, an information processing device (the server device 1) as an embodiment includes a control unit (the CPU 11: the use control unit 11c) that determines whether a use state of an imaging device (the camera 3) that performs image processing using an artificial intelligence model on a captured image obtained by capturing a subject corresponds to a specific use state, and performs disabling processing of disabling use of the artificial intelligence model in the imaging device in a case where it is determined that the use state corresponds to the specific use state. This makes it possible to disable the use of the imaging device in response to a case where the use state of the imaging device is inappropriate. Therefore, for a camera system using the imaging device that performs the image processing using the artificial intelligence model, the system can be prevented from being abused.

In addition, in the information processing device as the embodiment, the imaging device decrypts an encrypted artificial intelligence model received from the outside and uses the decrypted artificial intelligence model for the image processing, and the control unit performs processing of disabling the decryption of the artificial intelligence model in the imaging device as the disabling processing. If the decryption of the encrypted artificial intelligence model is disabled, the use of the artificial intelligence model can be disabled. Therefore, according to the above-described configuration, it is possible to realize disabling of use of the artificial intelligence model by a simple process of disabling the decryption, for example, by changing a key used for encryption or the like.

Furthermore, in the information processing device as the embodiment, the control unit performs a process of changing key information used to encrypt the artificial intelligence model as the disabling processing. When the key information used to encrypt the artificial intelligence model is changed as described above, decryption is disabled with the key information that has been used to decrypt the artificial intelligence model until then on the imaging device side. Therefore, the disabling of use of the artificial intelligence model can be realized by a simple process of changing the key information used to encrypt the artificial intelligence model.

In addition, in the information processing device as the embodiment, the imaging device is configured to decrypt the artificial intelligence model based on the key information, generated by multiplying a master key stored in advance in the imaging device and a designated key that is a key designated from the information processing device side, and the control unit performs processing of transmitting the artificial intelligence model encrypted based on the key information, generated by multiplying the master key and a key changed from the designated key, to the imaging device. As a result, the decryption of the artificial intelligence model transmitted from the information processing device is disabled in the imaging device. At this time, it is only necessary to change the designated key in order to disable the use of the artificial intelligence model. Therefore, the disabling of use of the artificial intelligence model can be realized by a simple process of changing the designated key. In addition, according to the above-described configuration, since it is necessary to use the master key for encoding of the artificial intelligence model, it is possible to prevent imaging devices other than a specific imaging device (imaging device as a compatible product) in which the master key is stored in advance from being able to decrypt and use the artificial intelligence model.

In addition, in the information processing device as the embodiment, the control unit performs the determination based on information acquired from the imaging device. Examples of the information acquired from the imaging device include the output data of the image processing using the artificial intelligence model, output information (for example, information on a position, an altitude, a temperature, motion, and the like) of various sensors included in the imaging device, and free space information of a memory used in the image processing using the artificial intelligence model. Data content, a data type, a data size, a data output frequency, and the like can be grasped based on output data of the image processing, and an environment, a situation, and the like in which the imaging device is placed can be grasped based on outputs of the various sensors included in the imaging device. In addition, it is possible to estimate what kind of processing is being performed as the image processing using the artificial intelligence model based on the free space information of the memory. Therefore, it is possible to appropriately estimate the use state of the imaging device, such as the environment and situation in which the imaging device is used and any subject on which the image processing is being performed by using the information acquired from the imaging device, so that it is possible to appropriately determine whether the use state corresponds to the specific use state.

Furthermore, in the information processing device as the embodiment, the control unit performs the determination based on the output data of the image processing acquired from the imaging device. This makes it possible to estimate a use state related to an execution mode of the image processing using the artificial intelligence model as the use state of the imaging device. Therefore, it is possible to determine whether the use state of the imaging device corresponds to the specific use state from the viewpoint of the execution mode of the image processing, for example, how frequently the image processing is performed on which subject or the like.

In addition, in the information processing device as the embodiment, the control unit performs the determination based on the output information of the sensors (for example, sensors in the sensor unit 36) included in the imaging device. This makes it possible to estimate the use state of the imaging device from the viewpoint of the location, the environment, the situation, and the like where the imaging device is used. Therefore, as the determination as to whether the use state of the imaging device corresponds to the specific use state, it is possible to perform the determination from the viewpoint of such use location, use environment, use situation, and the like.

In addition, in the information processing device as the embodiment, the control unit performs the determination based on the free space information of the memory used in the image processing acquired from the imaging device. This makes it possible to estimate a use state related to an execution mode of the image processing using the artificial intelligence model as the use state of the imaging device. Therefore, it is possible to determine whether the use state of the imaging device corresponds to the specific use state from the viewpoint of the execution mode of the image processing, for example, how frequently the image processing is performed on which subject or the like.

Furthermore, in the information processing device as the embodiment, the control unit performs the determination based on IP address information of the imaging device. This makes it possible to determine whether the use state of the imaging device corresponds to the specific use state from the viewpoint of a use location of the imaging device.

An information processing method as an embodiment is an information processing method by which a computer device executes a disabling control process of determining whether a use state of an imaging device that performs image processing using an artificial intelligence model on a captured image obtained by capturing a subject corresponds to a specific use state, and performing disabling processing of disabling use of the artificial intelligence model in the imaging device in a case where it is determined that the use state corresponds to the specific use state. According to such an information processing method, it is also possible to obtain actions and effects similar to those of the information processing device as the embodiment described above.

An imaging device (the camera 3) as an embodiment includes an image processing unit (the AI image processing unit 44) that performs image processing using an artificial intelligence model on a captured image obtained by capturing a subject, and a control unit (the sensor internal control unit 43) that switches a level of security processing for output data based on the output data of the image processing. According to the above-described configuration, it is possible to switch the level of the security processing by increasing the level of the security processing for output data for which an advanced security level is required and decreasing the level of the security processing for the other output data, and it is possible to achieve both ensuring the safety for the output data of the image processing using the artificial intelligence model and reducing a processing load of the imaging device.

In addition, in the imaging device as the embodiment, the security processing is encryption processing of the output data, and the control unit switches an encryption level of the output data as the switching of the level of the security processing. The term “switching of the encryption level” referred to herein is a concept including switching of the presence or absence of encryption and switching of the amount of data to be encrypted. For example, it is possible to encrypt the entire data for the output data for which the advanced security level is required and not to encrypt the other output data or to encrypt only some data by switching the encryption level based on a type of the output data, and it is possible to secure the safety for the output data of the image processing and reduce the processing load of the imaging device.

Furthermore, in the imaging device as the embodiment, the control unit encrypts the output data in a case where the output data is image data, and does not encrypt the output data in a case where the output data is specific data other than the image data. The image data output as a result of the image processing is assumed to be, for example, image data of a recognized face, whole body, half body, or the like in a case where a subject is a person, image data of a recognized license plate in a case where the subject is a vehicle, or the like. Therefore, it is possible to improve the safety by performing encryption in a case where the output data is the image data as described above. In addition, since encryption is not performed in a case where the output data is the specific data other than the image data, it is not necessary to perform the encryption processing on the entire output data, and the processing load of the imaging device can be reduced.

In addition, in the imaging device as the embodiment, the security processing is processing of adding electronic signature data for authenticity determination to the output data, and the control unit switches whether to add the electronic signature data to the output data as the switching of the level of the security processing. This makes it possible to achieve both securing the safety from the viewpoint of spoofing prevention and reducing the processing load on the imaging device.

A control method as an embodiment is a control method by which an imaging device performs control to switch a level of security processing for output data based on the output data of image processing, the control method being used in the imaging device including an image processing unit that performs the image processing using an artificial intelligence model on a captured image obtained by capturing a subject. According to such a control method, it is also possible to obtain actions and effects similar to those of the imaging device as the embodiment described above.

### 3. Other Embodiments

The processing according to the embodiment described above may be performed in various different forms (or modifications) other than the above embodiment. Further, among the respective processes described in the above embodiment, all or a part of the processes described as being performed automatically may be manually performed or the processes described as being performed manually can be performed automatically by known methods. In addition, the processing procedures, specific names, and information including various types of data and parameters illustrated in the above literatures and drawings can be arbitrarily changed unless otherwise specified. For example, various types of information illustrated in each drawing are not limited to the illustrated information.

In addition, each constituent element of each device illustrated is a functional concept, and does not necessarily need to be physically configured as illustrated. That is, the specific form of distribution/integration of each device is not limited to those illustrated in the drawings, and all or a part thereof may be functionally or physically distributed/integrated into arbitrary units according to various loads and usage situations.

Further, the above-described embodiment (or modifications) can be appropriately combined within a range that does not contradict processing contents. In addition, the effects described in the present specification are merely examples and are not restrictive of the disclosure herein, and other effects not described herein may be achieved.

### 4. Appendix

Note that the present technology can also have the following configurations.

(1)

An information processing device comprising:
a sensor that acquires image generation data; and
a conversion circuit that converts the image generation data based on a predetermined interface or data format acquired by the sensor into image generation data based on another interface or data format compatible with a processor.
   (2)

The information processing device according to (1), further comprising
the processor that processes the image generation data converted by the conversion circuit.
   (3)

The information processing device according to (2), wherein
the conversion circuit is a circuit in which logic is rewritable, and
the processor rewrites the logic according to a type of the sensor.
   (4)

The information processing device according to (3), further comprising
a memory that stores rewrite information for rewriting the logic, wherein
the processor rewrites the logic based on the rewrite information.
   (5)

The information processing device according to any one of (1) to (4), further comprising
a memory that stores configuration information regarding the sensor and the conversion circuit.
   (6)

The information processing device according to any one of (1) to (5), further comprising:
a sensor board on which the sensor is provided; and
a circuit board on which the conversion circuit is provided, wherein
the sensor board and the circuit board are formed to be detachably attached, and are formed in such a manner that the sensor and the conversion circuit are electrically connected in a state where the sensor board and the circuit board are attached.
   (7)

The information processing device according to (6), wherein
the sensor board and the circuit board are stacked.
   (8)

The information processing device according to (6) or (7), wherein
the sensor board and the circuit board have respective connection connectors based on an identical interface, and
the circuit board has an output connector that is for outputting the image generation data from the conversion circuit and based on an interface different from the interface.
   (9)

The information processing device according to (8), wherein
the connection connector for each of the sensor board and the circuit board is a coupling connector that couples the sensor board and the circuit board.
   (10)

The information processing device according to (6) or (7), wherein
the sensor board and the circuit board have respective connection connectors based on an identical interface, and
the circuit board has an output connector that is for outputting the image generation data from the conversion circuit and based on an interface identical to the interface.
   (11)

The information processing device according to (10), wherein
the connection connector for each of the sensor board and the circuit board is a coupling connector that couples the sensor board and the circuit board.
   (12)

An information processing system comprising:
a sensor that acquires image generation data;
a conversion circuit that converts the image generation data based on a predetermined interface or data format acquired by the sensor into image generation data based on another interface or data format compatible with a processor;
the processor that processes the image generation data converted by the conversion circuit; and
a server device that manages data to be used by the conversion circuit or the processor.
   (13)

The information processing system according to (12), wherein
the conversion circuit is a circuit in which logic is rewritable, and
the processor rewrites the logic according to a type of the sensor.
   (14)

The information processing system according to (13), wherein
the server device stores, as the data, management information for managing sensor information compatible with the sensor, and
the processor rewrites the logic based on the management information.
   (15)

The information processing system according to (14), wherein
the sensor information includes rewrite information for rewriting the logic,
the information processing system further comprises a memory that stores the rewrite information, and
the processor rewrites the logic based on the rewrite information.
   (16)

The information processing system according to (14), further comprising
a memory that stores configuration information regarding the sensor and the conversion circuit, wherein
the server device selects the sensor information from the management information based on the configuration information, and
the processor rewrites the logic based on the sensor information selected by the server device.
   (17)

The information processing system according to any one of (14) to (16), wherein
the sensor information includes driver information regarding a device driver compatible with the sensor, and
the processor controls the sensor based on the driver information.
   (18)

The information processing system according to any one of (14) to (17), wherein
the sensor information includes software information regarding signal processing software compatible with the sensor, and
the processor processes the image generation data converted by the conversion circuit based on the software information.
   (19)

An information processing circuit that converts image generation data based on a predetermined interface or data format acquired by a sensor into image generation data based on another interface or data format compatible with a processor.

(20)

An information processing method comprising converting image generation data based on a predetermined interface or data format acquired by a sensor into image generation data based on another interface or data format compatible with a processor.

(21)

An information processing system including the information processing device according to any one of (1) to (11).

(22)

An information processing method for processing information by the information processing device according to any one of (1) to (11).

(23)

An electronic apparatus including the information processing device according to any one of (1) to (11) or the information processing circuit according to (19).

### REFERENCE SIGNS LIST

1A INFORMATION PROCESSING SYSTEM
1B INFORMATION PROCESSING SYSTEM
1C INFORMATION PROCESSING SYSTEM
100 INFORMATION PROCESSING DEVICE
100A CAMERA
100B CAMERA
101 RGB SENSOR
102 SPECIAL SENSOR
102a POLARIZATION SENSOR
102b MSS
102c EVS
103 CONVERSION CIRCUIT
103A MEMORY
103a PROCESSING BLOCK
103b PROCESSING BLOCK
103c PROCESSING BLOCK
104 PROCESSOR
104A MEMORY
104a PROCESSING BLOCK
104b PROCESSING BLOCK
104c PROCESSING BLOCK
104d PROCESSING BLOCK
105 I/F BLOCK
106 I/F BLOCK
110 SENSOR BOARD
110a CONNECTION CONNECTOR
111 CIRCUIT BOARD
111a CONNECTION CONNECTOR
111b OUTPUT CONNECTOR
111c OUTPUT CONNECTOR
112 PROCESSOR BOARD
112a INPUT CONNECTOR
112b INPUT CONNECTOR
113 CONNECTION CABLE
150 SERVER DEVICE
160 TERMINAL DEVICE
170 EDGE BOX
171 INPUT UNIT
172 DISPLAY UNIT

1. An information processing device comprising:
a sensor that acquires image generation data; and
a conversion circuit that converts the image generation data based on a predetermined interface or data format acquired by the sensor into image generation data based on another interface or data format compatible with a processor.

2. The information processing device according to claim 1, further comprising
the processor that processes the image generation data converted by the conversion circuit.

3. The information processing device according to claim 2, wherein
the conversion circuit is a circuit in which logic is rewritable, and
the processor rewrites the logic according to a type of the sensor.

4. The information processing device according to claim 3, further comprising
a memory that stores rewrite information for rewriting the logic, wherein
the processor rewrites the logic based on the rewrite information.

5. The information processing device according to claim 1, further comprising
a memory that stores configuration information regarding the sensor and the conversion circuit.

6. The information processing device according to claim 1, further comprising:
a sensor board on which the sensor is provided; and
a circuit board on which the conversion circuit is provided, wherein
the sensor board and the circuit board are formed to be detachably attached, and are formed in such a manner that the sensor and the conversion circuit are electrically connected in a state where the sensor board and the circuit board are attached.

7. The information processing device according to claim 6, wherein
the sensor board and the circuit board are stacked.

8. The information processing device according to claim 6, wherein
the sensor board and the circuit board have respective connection connectors based on an identical interface, and
the circuit board has an output connector that is for outputting the image generation data from the conversion circuit and based on an interface different from the interface.

9. The information processing device according to claim 8, wherein
the connection connector for each of the sensor board and the circuit board is a coupling connector that couples the sensor board and the circuit board.

10. The information processing device according to claim 6, wherein
the sensor board and the circuit board have respective connection connectors based on an identical interface, and
the circuit board has an output connector that is for outputting the image generation data from the conversion circuit and based on an interface identical to the interface.

11. The information processing device according to claim 10, wherein
the connection connector for each of the sensor board and the circuit board is a coupling connector that couples the sensor board and the circuit board.

12. An information processing system comprising:
a sensor that acquires image generation data;
a conversion circuit that converts the image generation data based on a predetermined interface or data format acquired by the sensor into image generation data based on another interface or data format compatible with a processor;
the processor that processes the image generation data converted by the conversion circuit; and
a server device that manages data to be used by the conversion circuit or the processor.

13. The information processing system according to claim 12, wherein
the conversion circuit is a circuit in which logic is rewritable, and
the processor rewrites the logic according to a type of the sensor.

14. The information processing system according to claim 13, wherein
the server device stores, as the data, management information for managing sensor information compatible with the sensor, and
the processor rewrites the logic based on the management information.

15. The information processing system according to claim 14, wherein
the sensor information includes rewrite information for rewriting the logic,
the information processing system further comprises a memory that stores the rewrite information, and
the processor rewrites the logic based on the rewrite information.

16. The information processing system according to claim 14, further comprising
a memory that stores configuration information regarding the sensor and the conversion circuit, wherein
the server device selects the sensor information from the management information based on the configuration information, and
the processor rewrites the logic based on the sensor information selected by the server device.

17. The information processing system according to claim 14, wherein
the sensor information includes driver information regarding a device driver compatible with the sensor, and
the processor controls the sensor based on the driver information.

18. The information processing system according to claim 14, wherein
the sensor information includes software information regarding signal processing software compatible with the sensor, and
the processor processes the image generation data converted by the conversion circuit based on the software information.

19. An information processing circuit that converts image generation data based on a predetermined interface or data format acquired by a sensor into image generation data based on another interface or data format compatible with a processor.

20. An information processing method comprising converting image generation data based on a predetermined interface or data format acquired by a sensor into image generation data based on another interface or data format compatible with a processor.
